(19) United States
(12) Patent Application Publication
(10) Pub. No.: US 2013/0268886 A1
(43) Pub. Date: Oct. 10, 2013

(54) SYSTEMS AND METHODS FOR TRIP PLANNING AND MARKETING TRIP ITEMS

(71) Applicant: KACHINC, LLC, Redmond, WA (US)

(72) Inventor: Vijay Sureshkumar, Redmond, WA (US)

(73) Assignee: KACHINC, LLC, Redmond, WA (US)

(21) Appl. No.: 13/842,765

(22) Filed: Mar. 15, 2013

Related U.S. Application Data
(60) Provisional application No. 61/622,343, filed on Apr. 10, 2012.

(51) Int. Cl. G06F 3/0484

(52) U.S. Cl. CPC G06F 3/04842
USPC 715/810

(57) ABSTRACT

In some embodiments, systems and methods for assisting in trip planning are provided. A calendar interface is presented to a traveler. In some embodiments, trip items may be added by the traveler to the calendar interface via import, entry, or selection from a trip item tray. In some embodiments, trip items may be presented in a trip item tray based on a match rank value representing a correspondence between preferences associated with the trip and attributes of the trip items. In some embodiments, interfaces may be presented to a supplier of trip items that allow the supplier to push relevant trip items to selected travelers during their travel upon detection of a push event.

### CROSS-REFERENCE TO RELATED APPLICATION

This application claims the benefit of Provisional Application No. 61/622,343, filed Apr. 10, 2012, the entire disclosure of which is hereby incorporated by reference herein.

### BACKGROUND

Most travel web sites and applications today do not provide services that align well with typical stages of a trip, from conception to execution, for the purposes of planning, researching, sharing and booking. Travelers have to look for information on multiple sites, check prices on multiple sites, and book on multiple sites. Furthermore, there is no easy way to visualize the overall trip and keep it an enjoyable process from conception of the trip to execution of the trip. There is no currently available service that guides the traveler through the trip providing the right information at the right time and getting them to make decisions about the trip at various stages at the appropriate times.

Most travel sites and mobile apps today provide separate list views of flights, hotels, ground transportation, activities and events (or a combination of them) but do not provide an easy way to visualize the trip and make decisions easier and less stressful. The items may be purchased as a bundle or individually, but the selections are usually made from a list of offerings. There is no easy way to choose the offerings based on a visual representation of the trip so that there is good context of the trip to aid in making decisions to make the sum total of the trip items work logistically and to make the whole process enjoyable.

The searches for trip items are usually done with specific dates in mind (with options to include additional dates). There is currently no system that provides an easy way to search for all possibilities within the context of a trip to allow users to “experiment” with the placement and duration of various trip items in their trip. Calendar utilities have not been provided in the context of travel or trips to allow users to visualize their trip, including visualizing different types of events at the same time (such as transportation, lodging, and activities). Existing calendar utilities also do not use the knowledge of location and the trip plan of the traveler to provide additional help, for example, using the traveling time between the locations of two events in a trip to present the feasibility to the user.

From point of view of suppliers of events and services that may be attended or utilized during a trip, there are not currently any valuable services that provide a list of travelers with committed trips, along with guidance on how well the suppliers' offerings match the traveler's trip. Existing services fail to provide suppliers with these high value leads and opportunities to convert them to customers. While many web sites and mobile apps allow users to check-in online, such services only keep track of the user's current or past locations or check-ins, without the ability to predict likely future locations and check-ins.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a system for travel planning is provided. The system comprises at least one computing device configured to provide at least a traveler interface engine. The traveler interface engine is configured to present a trip calendar configured to present a set of scheduled trip items associated with a trip, present a list of proposed items for selection, receive a selection of a proposed trip item, and add the selected proposed trip item to the trip calendar.

In some embodiments, a computer-implemented method for presenting trip items to a traveler is provided. The method comprises receiving a set of trip item offers to be pushed to a traveler associated with a trip; and, for each trip item offer in the set of trip item offers, determining an appropriate push event for causing the trip item offer to be pushed to the traveler, and transmitting the trip item offer to the traveler for consideration in response to detecting the push event.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an exemplary life cycle of a trip according to various aspects of the present disclosure;

FIG. 2 is a block diagram that illustrates an exemplary embodiment of a trip planning system according to various aspects of the present disclosure;

FIGS. 3A-3E are a flowchart that illustrates an exemplary embodiment of a method of scheduling trip items according to various aspects of the present disclosure;

FIG. 4 is a flowchart that illustrates an exemplary embodiment of a procedure suitable for use for selecting trip item offers to be pushed to a traveler computing device, as discussed with regard to block 346 in FIG. 3E;

FIG. 5 is a flowchart that illustrates an exemplary embodiment of another procedure suitable for use for selecting trip item offers to be pushed to a traveler computing device, as discussed with respect to block 346 in FIG. 3E;

FIG. 6 illustrates an exemplary trip planning interface presented by the traveler interface engine according to various aspects of the present disclosure;

FIG. 7 illustrates an exemplary trip planning interface presented by the traveler interface engine upon selecting a “trip map” tab, according to various aspects of the present disclosure;

FIG. 8 illustrates an exemplary trip planning interface presented by the traveler interface engine upon selecting a “photos/journal” tab, according to various aspects of the present disclosure;

FIG. 9 illustrates an exemplary trip planning interface having functionality similar to the functionality of the trip planning interface illustrated in FIG. 6, but adapted for display by a traveler mobile computing device, according to various aspects of the present disclosure;

FIG. 10 illustrates a view portion of an exemplary supplier dashboard interface presented by the supplier interface engine according to various aspects of the present disclosure;

FIG. 11 illustrates a push portion of an exemplary supplier dashboard interface presented by the supplier interface engine according to various aspects of the present disclosure;

FIG. 12 illustrates a deal pushing dialog of an exemplary supplier dashboard interface presented by the supplier interface engine according to various aspects of the present disclosure;

FIG. 13 illustrates an exemplary embodiment of an interface suitable for establishing auto-push settings according to various aspects of the present disclosure;

FIG. 14 shows an exemplary embodiment of a trip calendar user interface (“UI”), similar to the interface illustrated in FIG. 6, according to various aspects of the present disclosure;

FIG. 15 illustrates an exemplary interface that shows the creation of trip items, in accordance with various aspects of the present disclosure;

FIG. 16 illustrates an exemplary interface that shows a trip calendar in the conception phase of trip planning, in accordance with various aspects of the present disclosure;

FIG. 17 illustrates an exemplary interface that presents a list of trips by date along with information about what has been scheduled for each trip, according to various aspects of the present disclosure;

FIG. 18 illustrates an exemplary interface that presents a “supplier view” of a trip calendar, in accordance with various aspects of the present disclosure;

FIG. 19 illustrates an exemplary interface that presents trip recommendations received from social media service providers, according to various aspects of the present disclosure;

FIG. 20 illustrates an exemplary interface that enables the creation of a trip based on a list of variations of a dream trip posted by members of a social circle, in accordance with various aspects of the present disclosure;

FIGS. 21A and 21B illustrate an exemplary interface that presents a set of trip item offers to a traveler, and allows the traveler to add trip item offers to a calendar interface according to various aspects of the present disclosure;

FIG. 22 illustrates an exemplary interface that presents a location-based supplier view of a specific trip, in accordance with various aspects of the present disclosure;

FIG. 23 illustrates an exemplary interface that presents a location-based supplier view, in accordance with various aspects of the present disclosure;

FIG. 24 illustrates an exemplary interface that presents a location-based supplier view of multiple trips, in accordance with various aspects of the present disclosure; and

FIG. 25 illustrates aspects of an exemplary computing device 2500 appropriate for use with embodiments of the present disclosure.

### DETAILED DESCRIPTION

System Overview

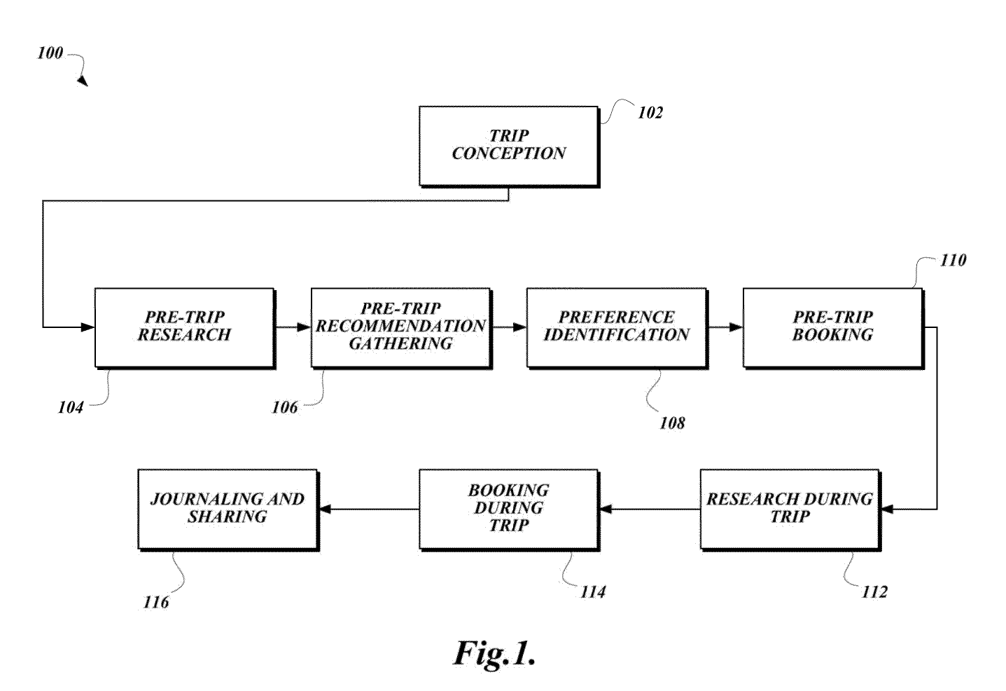

FIG. 1 illustrates an exemplary life cycle of a trip according to various aspects of the present disclosure. As illustrated, many trips start as thoughts in travelers' minds, in a trip conception stage 102. Sometimes, a traveler has a budget in mind, a specific destination or class of destinations based on what the traveler intends to do during the trip (beach town, sports, wine tasting, family visit, etc.), an approximate time of travel, and other trip-defining criteria. In a pre-trip research stage 104, the traveler may explore the destinations online for more information, and in a pre-trip recommendation gathering stage 106, the traveler may ask friends and co-workers for suggestions. In a preference identification stage 108, one or more preferences to be associated with the trip, such as preferred air carriers, hotel classes or locations, types of preferred activities, and/or the like may be gathered. After the traveler decides on a destination, the traveler may research the big items on their trip, such as a mode of transportation, lodging, package tours, and/or the like. After shopping around for the big items, the traveler may start thinking about things to do during the trip, ground transportation during the trip, etc. The order could be reversed if the trip is centered around an activity or event that needs to be booked first like a golf tee time, a concert, a ski resort lift ticket, and/or the like. Once these items are identified, the traveler may book these items before the trip in a pre-trip booking stage 110. Travelers tend to continue to research, identify preferences, explore, and book travel items during the trip as well, in a research during trip stage 112 and a booking during trip stage 114. Travelers may also share travel logs, journals, photos, videos and other media both during the trip and after the trip, during a journaling and sharing stage 116, which may take place before, during, or after any of the other illustrated stages.

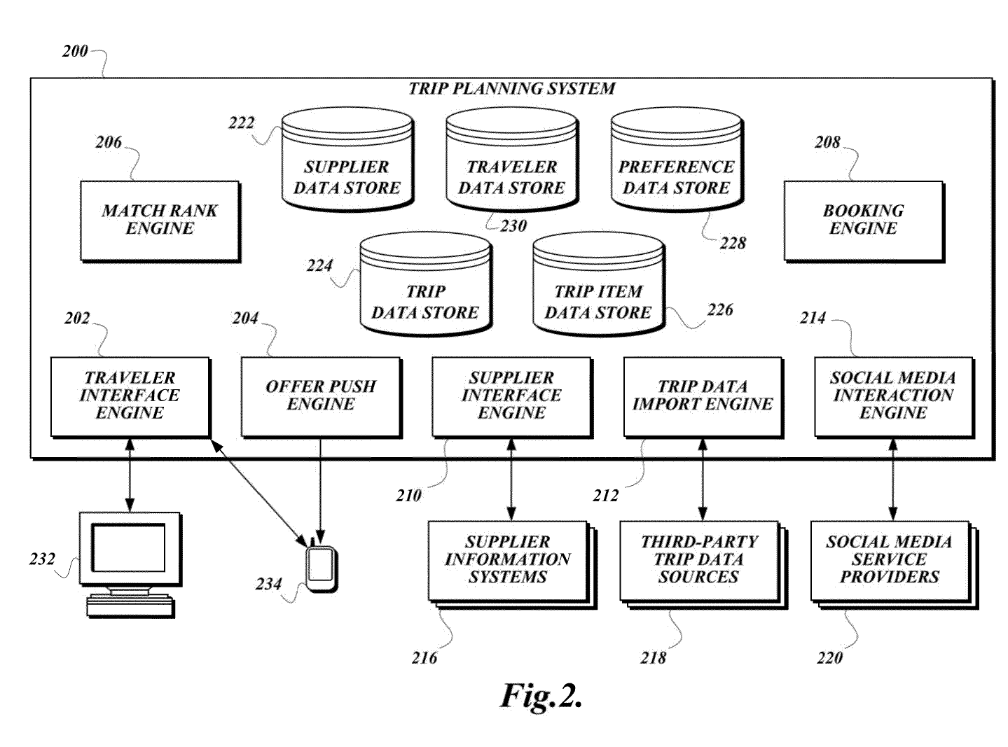

FIG. 2 is a block diagram that illustrates an exemplary embodiment of a trip planning system 200 according to various aspects of the present disclosure. As described in further detail below, the trip planning system 200 may provide services to travelers including the presentation of an interface that includes a calendar interface and one or more trip item trays. The interface allows a traveler to create a trip, and to add trip items from the trip item trays to the trip via the calendar. The interface may populate the trip item trays with sets of items that are automatically determined to be likely of interest to the traveler based on attributes associated with the trip and/or the traveler. The interface may also allow manual entry of trip items by the traveler. The interface may also allow the traveler to share trip information via one or more social media services (or via any other suitable method), and may allow the traveler to enter journal information to be associated with the trip.

As also described in further detail below, the trip planning system 200 may provide services to suppliers of trip items to help suppliers market trip items to travelers. For example, the trip planning system 200 may provide an interface that allows suppliers to choose trips that the suppliers believe are associated with travelers who would be interested in the trip items offered by the suppliers, and may subsequently push offers associated with the trip items to the traveler. As another example, the trip planning system 200 may automatically determine trip items associated with the suppliers that are relevant to a given trip, and may subsequently push the automatically determined relevant trip items to the traveler. Pushed trip items may be viewed by the traveler before or during the trip to help fill otherwise empty time in the traveler's schedule.

The present disclosure uses terms related to trip planning, such as “trip,” “trip item,” “traveler,” and “supplier.” A “trip” is typically understood to be a period of time in which one or more travelers travel to a destination, perform various activities, and then leave the destination. However, a “trip” should also be understood to include travel to and from more than one destination, travel that does not include any activities, activities at a location that does not require travel to or return from the location, and/or the like. A “traveler” is typically understood to be a person planning a trip or going on a trip, and this is how the term is primarily used below. However, a trip may include more than one traveler traveling together, and any one (or more than one) of the travelers may be the “traveler” described below as interacting with the trip planning system 200. Also, a trip may be planned by a person who is not going on the trip, in which case the “traveler” described below as interacting with the trip planning system 200 before travel would be the trip planner, while the “traveler” interacting with the trip planning system 200 during travel may be the person on the trip. A “trip item” refers to any type of item that may be scheduled to be included in a trip, such as a flight, a lodging, an activity, an event, local transportation, and/or the like. A trip item may be an activity, event, and/or the like that requires a ticket, a reservation, or otherwise requires communication with a third party to ensure participation in the trip item, or may simply be a period of time reserved for an activity, event, and/or the like that does not require a reservation. A “supplier” refers to a third party that provides a trip event, or at least lists a trip event as available through the trip planning system 200. Some examples of suppliers include, but are not limited to, museums, restaurants, ticket purchasing services, theaters, theme parks, sports teams, tour guides, park services, tourism bureaus, and/or the like.

In some embodiments, the trip planning system 200 includes a traveler interface engine 202, an offer push engine 204, a match rank engine 206, a booking engine 208, a supplier interface engine 210, a trip data import engine 212, and a social media interaction engine 214. In general, an “engine” as described herein refers to logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. An engine may be compiled into executable programs or written in interpreted programming languages. Software engines may be callable from other engines or from themselves. Generally, the engines described herein refer to logical modules that can be merged with other engines, or can be divided into sub engines. The engines can be stored in any type of computer readable medium or computer storage device and be stored on and executed by one or more processors of a general purpose computing device, thus creating a special purpose computing device configured to provide the engine and/or the functionality thereof.

The traveler interface engine 202 is configured to generate one or more interfaces for use by travelers in interacting with the trip planning system 200. The interfaces may include user interfaces to be presented to the traveler, application programming interfaces (APIs) that provide data and functions for access by applications run by the traveler or computing devices associated with the traveler, or both. The interfaces generated by the traveler interface engine 202 may be presented to the traveler directly by a computing device associated with the trip planning system 200; by a desktop traveler computing device 232 such as a desktop computing device, a laptop computing device, and/or the like; by a mobile traveler computing device 234 such as a smartphone, a tablet computing device, and/or the like; and/or by any other suitable computing device. In some embodiments, the traveler interface engine 202 uses the interfaces to present trip-related information to the traveler, as well as to receive input from the traveler. In some embodiments, the traveler interface engine 202 may receive input from the traveler via selections or data entry into the interfaces, as well as by automatic transmission by the traveler computing device (such as automatic transmission of location information, check-in information, and/or the like, without any interaction required from the traveler).

In some embodiments, the offer push engine 204 is configured to communicate trip item offers to a mobile traveler computing device 234. A trip item offer includes an association between a trip item and a push event, wherein detection of the push event by the offer push engine 204 causes the trip item offer to be sent to the mobile traveler computing device 234. In some embodiments, a trip item offer may include information other than information identifying and describing the trip item, such as trip item type information, special pricing offers, discounts, special availability information, and/or the like. In some embodiments, a push event may be related to a time (either a current time for which the trip item offer would be pushed as soon as possible, or a time/date in the future at which the trip item offer would be pushed), a check-in at a specified location, an arrival in a geographic area within a predetermined radius of a particular location, and/or any other suitable event. In some embodiments, the trip item offer may also include an expiration event, wherein detection of the expiration event causes further presentation of the trip item offer to the traveler to be prevented. The expiration event may be determined based on any suitable attribute of the trip or the trip item, such as an amount of an offered discount, a match rank score, and/or the like. Some non-limiting examples of expiration events are detection of a predetermined elapsed period of time since a first presentation of the trip item offer or a start of the trip; a check-in outside of a predetermined geographic area; a rejection by the traveler; a booking of a different trip item, and/or the like. Though FIG. 2 illustrates the offer push engine 204 as communicating with only the mobile traveler computing device 234, in some embodiments, the offer push engine 204 may communicate trip item offers to the traveler desktop computing device 232 or any other traveler computing device. The offer push engine 204 may transmit trip item offers to the traveler computing device using any suitable technique, several examples of which are discussed further below.

The match rank engine 206 is configured to assign match rank scores to trip items based on a comparison of attributes of the trip items to attributes associated with a trip. The match rank scores may then be used to select a set of trip items most likely to be desirable to a traveler during the trip in order to present those trip items to the traveler for possible scheduling during the trip. The calculation and use of match rank scores is discussed in further detail below.

The booking engine 208 is configured to communicate with one or more supplier information systems 216 and/or one or more traveler financial institutions (not illustrated) in order to purchase and/or reserve trip items that have been scheduled for a trip. For example, the booking engine 208 may receive a scheduled trip item for a sporting event. Tickets for the sporting event may be made available by an online ticketing service, such as Ticketmaster®, Brown Paper Tickets, Listicket, or any other online ticketing service. The booking engine 208 may retrieve traveler payment information or account information from a traveler data store 230, and may communicate with the online ticketing service to buy tickets to the sporting event using the traveler payment or account information. The purchase of sporting event tickets is only an example, as flights, hotels, car rentals, restaurant reservations, or any other trip item that may be purchased or reserved via a supplier information system 216 may be purchased or reserved by the booking engine 208.

The supplier interface engine 210 is configured to generate one or more interfaces for use by suppliers in interacting with the trip planning system 200. As discussed above with respect to the traveler interface engine 202, the supplier interface engine 210 may generate a user interface, an API, or both, and may present the interface directly to the supplier by a computing device associated with the trip planning system 200, by a computing device associated with a supplier information system 216, or by any other suitable computing device. As discussed further below, in some embodiments, the supplier interface engine 210 is configured to present anonymized information about trips within a trip data store 224 to suppliers so that suppliers may choose one or more trip items to be pushed to travelers associated with the trips. The supplier interface engine 210 may also allow suppliers to add, modify, and remove trip items offered by the supplier and stored in a trip item data store 226 of the trip planning system 200. Further description of these features is provided below.

The trip data import engine 212 is configured to communicate with one or more third-party trip data sources 218 to import trip information created in other systems into the trip planning system 200. For example, a traveler may arrange trip items by themselves and record them in an itinerary tracker third-party trip data source 218 such as Tripit.com and/or the like. The trip data import engine 212 may connect to Tripit.com to collect the entered itinerary information and save it in the trip data store 224. Similar information may be retrieved from a third-party trip data source 218 such as Expedia, Orbitz, and/or the like. As another example, the trip data import engine 212 may connect to a calendar provider, such as Google Calendar, Yahoo! Calendar, and/or the like, to collect appointment or other event information for inclusion in a trip. As yet another example, the trip data import engine 212 may receive trip data submitted by a traveler for inclusion in a trip, such as by accepting a reservation confirmation email, an .ICS calendar information file, and/or the like. In some embodiments, the trip data import engine 212 may also be configured to retrieve trip information from past, current, and/or future trips stored in the trip data store 224 for import into a new trip.

The social media interaction engine 214 is configured to communicate with one or more social media service providers 220, such as Facebook, Twitter, Linkedln, or any other social media service provider currently existing or created in the future, for various purposes. For example, the social media interaction engine 214 may submit trip information to a social media service provider 220 in order to seek recommendations from social network connections of a traveler. The social media interaction engine 214 may receive the recommendations from the social media service provider 220, and associate the recommendations with the trip for presentation to the traveler. As another example, the social media interaction engine 214 may post journal entries, check-ins, photos, and/or the like in association with a trip to a social media service provider 220 to allow a traveler to share trip experience with social network connections. As yet another example, the social media interaction engine 214 may use information such as friend connections, social circle memberships, “like” information, and other user information obtained from social media service providers 220 as input for match rank calculations in order to improve the relevance of suggested items.

In some embodiments, the trip planning system 200 includes a supplier data store 222, a trip data store 224, a trip item data store 226, a preference data store 228, and a traveler data store 230. As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network or provided as a cloud-based service. A data store may also include data stored in an organized manner on a storage medium 2508, as described further below. One of ordinary skill in the art will recognize that separate data stores described herein may be combined into a single data store, and/or a single data store described herein may be separated into multiple data stores, without departing from the scope of the present disclosure.

The supplier data store 222 is configured to store information regarding one or more suppliers of trip items. The information may include connection and/or data translation information for communication between an associated supplier information system 216 and the supplier interface engine 210, user login and password information for users associated with the supplier, and/or any other information relevant to the supplier.

The trip data store 224 is configured to store information associated with one or more trips. Each trip includes at least a start date, an end date, and identifying information used to identify the trip. The trip data store 224 may also store information for one or more scheduled trip items associated with the trip, trip item offers associated with the trip, and/or favorite trip items associated with the trip. The trip data store 224 may also store other information associated with each trip, such as trip type information, one or more travelers associated with the trip, and/or any other suitable information. Types of information stored in the trip data store 224 are discussed further below.

The trip item data store 226 is configured to store information associated with one or more trip items. Each trip item stored in the trip item data store 226 may be associated with a supplier, and may include trip item attributes such as a description, pricing information, location information, availability information, seasonality information, preferable weather information, and/or any other suitable information for identifying and describing a trip item. The trip item data store 226 may also include information for trip items manually entered by travelers via a traveler interface, and/or may include information for one or more trip item offers as described above.

The preference data store 228 is configured to store preference information. In some embodiments, preference information may be associated with each trip in the trip data store 224, such that recommendations and match rank scores may be determined on a trip-by-trip basis, as opposed to a per-traveler basis, since a given traveler may have very different preferences for a family trip versus a business trip. In some embodiments, default preference information may be associated with a traveler to be automatically applied to new trips created by the traveler. Further description of trip preferences and data stored in the preference data store 228 is provided below.

The traveler data store 230 is configured to store information regarding one or more travelers. In some embodiments, the information may include user login and password information, contact information, identification information, billing information, and/or the like. In some embodiments, the information may also include account information for third-party systems associated with the traveler, such as social media accounts with one or more social media service providers 220, accounts at various third-party trip data sources 218, payment accounts, and/or the like. In some embodiments, the traveler information may include information for travelers who actively use the trip planning system 200 to plan travel, as well as information for travelers who do not actively use the trip planning system 200 but who accompany travelers who do. For instance, the traveler data store 230 may be configured to store information for both a parent (who schedules travel and actively uses the trip planning system 200) and that parent's children (who accompany the parent on travel). In some embodiments, the traveler information may include a trail of check-ins associated with the traveler, including geographical locations of the check-ins, friendly names of the check-in locations or event, types of locations for which check-ins were made, and/or the like. The check-in trail information may be usable to predict a current or future location of the traveler, as well as types of locations and/or events that the traveler is likely to prefer. In some embodiments, the check-in trail information may also include stored predictions of future locations of the traveler based on scheduled trip items associated with one or more trips associated with the traveler.

Scheduling and Pushing Trip Items

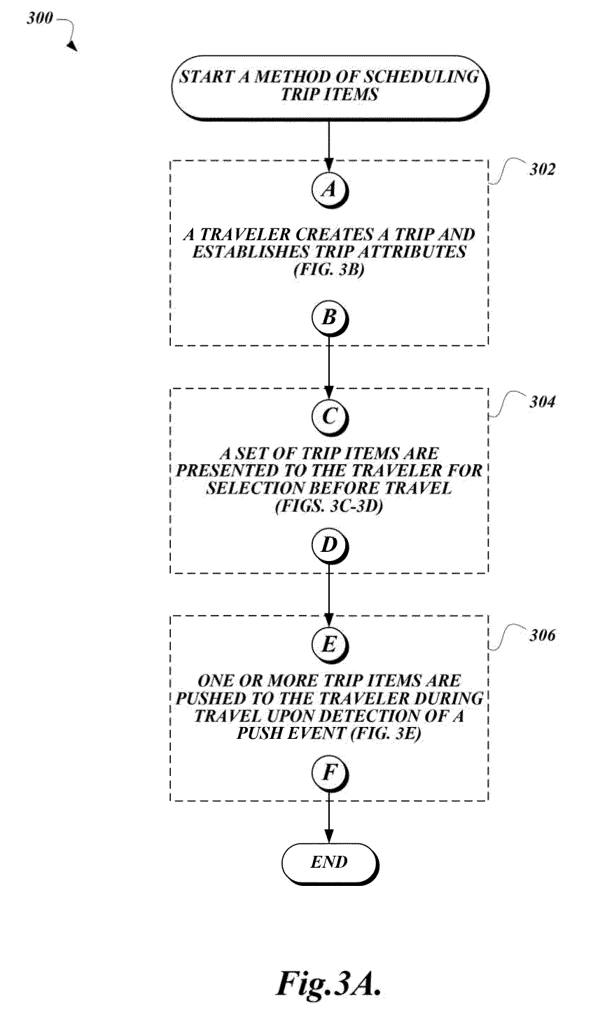

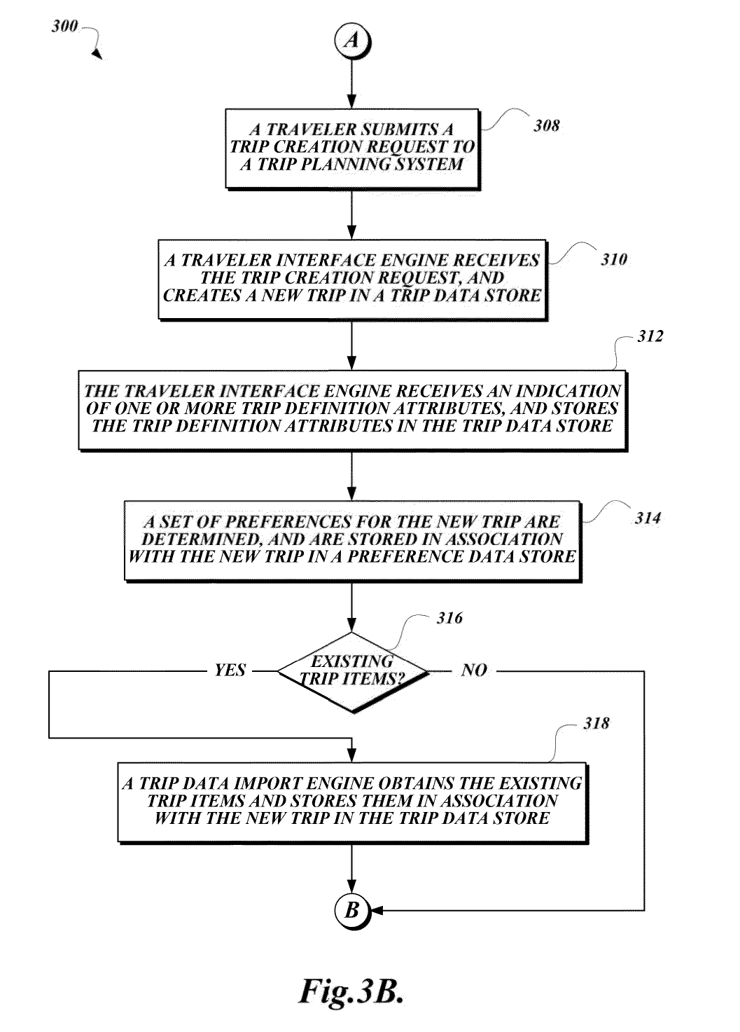

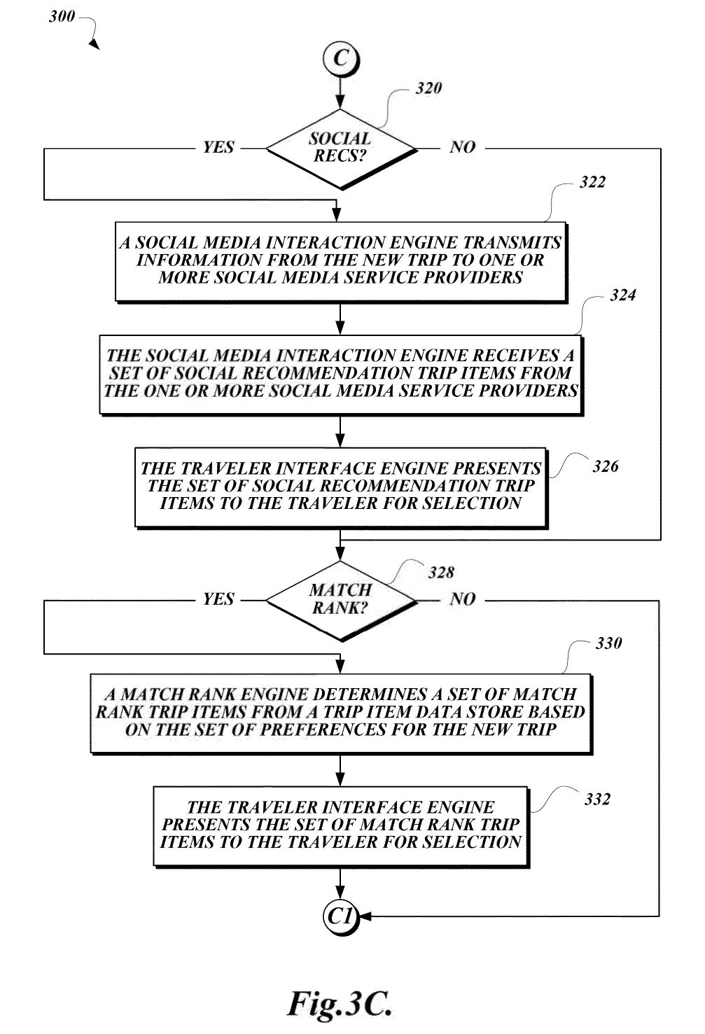

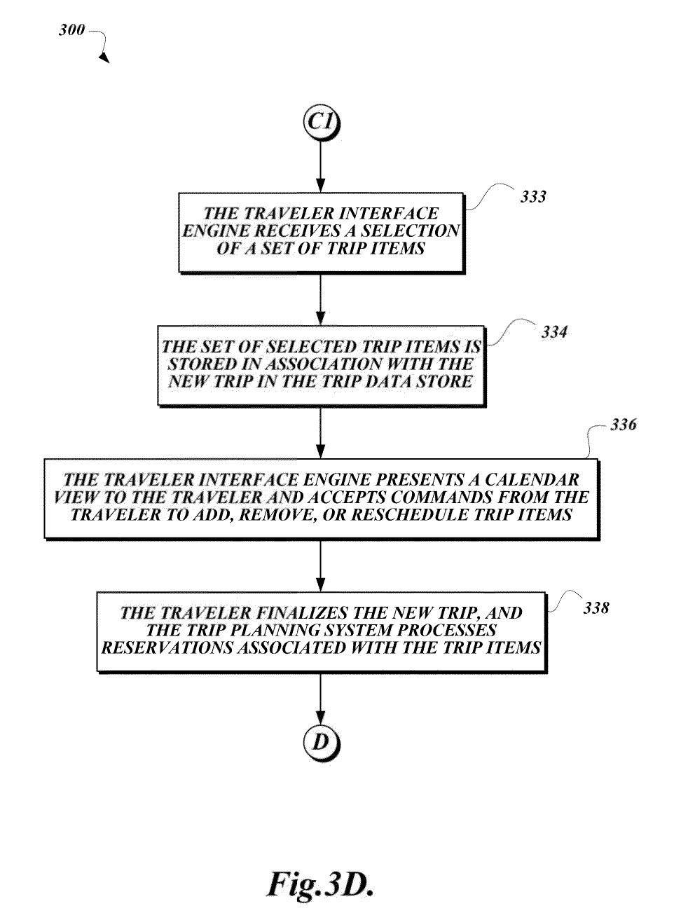

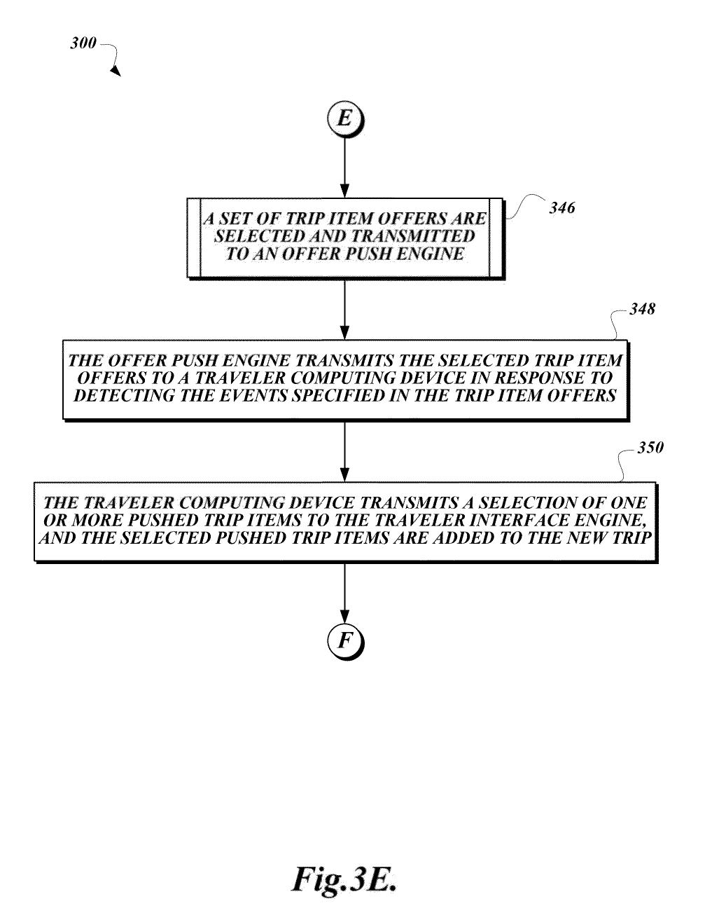

FIGS. 3A-3E are a flowchart that illustrates an exemplary embodiment of a method 300 of scheduling trip items according to various aspects of the present disclosure. From a start block, the method 300 proceeds to a set of method steps 302 defined between a start terminal (“terminal A”) and an exit terminal (“terminal B”). The set of method steps 302 includes actions wherein a traveler creates a trip and establishes trip attributes.

From terminal A (FIG. 3B), the method 300 proceeds to block 308, where a traveler submits a trip creation request to a trip planning system 200. The trip creation request may be submitted via a suitable interface presented by the traveler interface engine 202, and via a traveler computing device such as desktop traveler computing device 232, mobile traveler computing device 234, and/or via any suitable technique. Next, at block 310, a traveler interface engine 202 receives the trip creation request, and creates a new trip in a trip data store 224. The new trip may be associated with an account for the traveler and/or other information associated with the traveler and stored in the traveler data store 230. At this point, the new trip may include only simple identifying information such as a trip name and/or the like. At block 312, the traveler interface engine 202 receives an indication of one or more trip definition attributes, and stores the trip definition attributes in the trip data store 224. The trip definition attributes may include, but are not limited to, a start date, an end date or trip duration, a trip type (such as business, romantic, adventure, culture, family, offbeat, touristy, nightlife, and/or any other trip type), a number of travelers, the identity/ages of the travelers associated with the trip, one or more destinations associated with the trip, and the like.

At block 314, a set of preferences for the new trip are determined, and are stored in association with the new trip in a preference data store 228. In some embodiments, the set of preferences may initially be populated based on default preferences associated with the traveler and stored in the traveler data store 230. In some embodiments, the set of preferences may initially be populated based on past trips of the same type created by the traveler, past trips of the same type created by other travelers, and/or past trips of other types created by the traveler. In some embodiments, the set of preferences may be determined at least in part by one or more “likes” or other connections made by the traveler in a social media account with a social media service provider 220.

The set of preferences may include preferences in various categories, including, but not limited to, general preferences, activities/events preferences, flight preferences, lodging preferences, transport preferences, and/or the like. General preferences may include preferences applicable to multiple different types of trip items, such as price sensitivity, traveler information (such as age of travelers, gender of travelers, mobility constraints of travelers, and/or the like), and so on. Activities/events preferences may include preferences applicable to particular activities or events, such as a top N picks for particular activities or events to be included in a trip (if the trip planning system 200 finds a matching trip item offer or availability of the activities or events during the trip), favorite categories of activities or events (such as adventure, theme parks, museums, tours, shows, concerts, plays, games, and the like), keywords representing the traveler's preferences for activities or events (such as sports team names, artist names, genres of music, and the like), and the like. Flight preferences may include an ordered list of preferred carriers, frequent flyer account information, preferred departure and/or arrival times, preferred airports, preferred number of stops, and the like. Lodging preferences may include a top N picks for particular lodgings for the dates of travel and destination (if the trip planning system 200 finds a matching trip item offer or availability of the lodging during the trip), types of lodging (hotel, hostel, bed and breakfast, rental apartment, time share, and the like), keywords, desired and/or required amenities (such as wifi connections, complimentary breakfast, gym access, suites, views, parking, and the like), distance from a location such as a city center or airport, and the like. Transport preferences may include preferred types of transportation (such as shared-ride shuttle, taxi, limos, trains, rental cars, mass transit, and the like), preferred vehicle sizes, preferred rental car transmissions (manual or automatic), and the like.

The method 300 proceeds to a decision block 316, where a determination is made as to whether pre-existing trip items should be added to the trip. In some embodiments, the determination may be made based on a traveler response to an interface prompt asking whether pre-existing trip items should be added, though the determination may be made based on other factors, such as a system setting, a presence or absence of third-party trip data source account information in the traveler data store 230, and/or any other suitable factor. If the result of the determination at decision block 316 is YES, then the method 300 proceeds to block 318, where a trip data import engine 212 obtains the existing trip items and stores them in association with the new trip in the trip data store 224. In some embodiments, the trip data import engine 212 may obtain the existing trip items from a third-party data source 218 such as Tripit, Expedia, and/or the like, which stores itinerary information for existing trip items such as flights, car rentals, hotels, and/or the like that have already been booked by the traveler. The trip data import engine 212 may access the existing trip items programmatically via an API provided by the third-party data source 218, or using any other suitable technique. In some embodiments, the trip data import engine 212 may work with the traveler interface engine 202 to obtain information about existing trip items directly from the traveler via manual input. This may be useful in situations where the existing trip items have been booked via an online service that is not programmatically available as a third-party data source 218, or for existing trip items that are not scheduled using an online service (such as attending a wedding, conducting a business meeting, visiting a friend, and the like).

After block 318, or if the answer to the determination at decision block 316 is NO, the method 300 proceeds to terminal B. From terminal B (FIG. 3A), the method 300 proceeds to a set of method steps 304 defined between a start terminal (“terminal C”) and an exit terminal (“terminal D”). The set of method steps 304 includes actions wherein a set of trip items are presented to the traveler for selection before travel. In some embodiments, the trip items to be selected may be stored in the trip item data store 226. In some embodiments, the trip items may be stored in the trip item data store 226 upon entry of the trip items by suppliers via an interface presented by the supplier interface engine 210. In some embodiments, the trip items may be collected automatically by the supplier interface engine 210 from supplier information systems 216 via one or more APIs or data feeds.

From terminal C (FIG. 3C), the method 300 proceeds to a decision block 320, where a determination is made as to whether social trip item recommendations will be sought for the trip. In some embodiments, the determination may be made based on a traveler response to an interface prompt asking whether social trip item recommendations should be sought, though the determination may be made based on other factors, such as a system setting, a presence or absence of social media account information in the traveler data store 230, and/or any other suitable factor. If the result of the determination at decision block 320 is YES, then the method 300 proceeds to block 322, where a social media interaction engine 214 transmits information from the new trip to one or more social media service providers 220. In some embodiments, the information from the new trip transmitted to the social media service providers 220 may include a trip location, the start and/or end dates of the trip, one or more scheduled trip items, one or more match rank trip items (discussed further below), and/or any other information associated with the trip. The social media interaction engine 214 may communicate with the social media service provider 220 via an API provided by the social media service provider 220 or via any other suitable means.

Once the social media service provider 220 receives the information from the new trip, the social media service provider 220 may share one or more posts with social media connections of the traveler that relate to the information from the new trip. For example, posts related to the new trip may be created on the traveler's Facebook timeline, or tweets may be created in the traveler's Twitter feed. In some embodiments, the posts, tweets, or other social media messages may include links to view more information or provide feedback about the trip via the traveler interface engine 202. In some embodiments, the information received by the social media service provider 220 may be used by an app executed within the social media service to receive feedback from the traveler's social media connections about the trip information.

In some embodiments, upon posting the trip information, the traveler interface engine 202 or an app executed within the social media service may receive recommendations from the traveler's social media connections of trip items that they believe the traveler should add to the trip. At block 324, the social media interaction engine 214 receives a set of social recommendation trip items from the one or more social media service providers 220. Next, at block 326, the traveler interface engine 202 presents the set of social recommendation trip items to the traveler for selection. In some embodiments, the set of social recommendation trip items may be presented to the traveler via a trip item tray, as described below. In some embodiments, the set of social recommendation trip items may be presented to the traveler in a list, and the traveler may be presented with the ability to confirm or reject each trip item within the list. In some embodiments, the set of social recommendation trip items may be automatically added to the trip if they do not conflict with scheduled trip items, and the traveler would delete the items from the trip if they are not desirable.

After block 326, or if the result of the determination at block 320 is NO, the method 300 proceeds to a decision block 328, where a determination is made as to whether match rank recommendations should be sought for the trip. In some embodiments, the determination may be made based on a traveler response to an interface prompt asking whether match rank recommendations should be sought, though the determination may be made based on other factors, such as a system setting, a presence or absence of preference data, and/or any other suitable factor. The match rank process determines a set of trip items stored in a trip item data store 226 that are likely to be desirable to the traveler for the trip, based at least on one or more attributes of the trip and one or more attributes of the determined trip items.

If the result of the determination at block 328 is YES, then the method 300 proceeds to block 330, where a match rank engine 206 determines a set of match rank trip items from a trip item data store 226 based on the set of preferences for the new trip. In general, match rank values are calculated by the match rank engine 206 for one or more trip items from the trip item data store 226 by comparing at least attributes of the trip items to preferences associated with the trip.

For example, trip items may include information that corresponds to the preferences described above, such as price ranges (for price sensitivity preferences), keywords to be matched, categories of activities or events, air carrier identifiers, lodging types, hotel star ratings, transportation types, and/or the like. Matches between this information and the trip preferences may be weighted to produce at least a component of the match rank value. For example, for hotel trip items, a weight of 10 may be given to a trip item that has a star rating within +/−^{1/2} star of a preferred star rating, a weight of 50 may be given to a trip item that matches a view or suite preference, a weight of 100 may be given to a trip item with a hotel name that matches a hotel name preference, a weight of 10 may be given to each matching amenity, and/or the like. As another example, for activity trip items, a weight of 50 may be given to a category match, a weight of 10 may be given to each keyword match, and a weight of 100 may be given for each specific activity match. The weights for each matching preference may be combined to give a total match rank value for the trip item, and trip items having match rank values over a predetermined threshold, and/or a top N trip items ordered by match rank value, may be selected for the set of match rank trip items.

In some embodiments, at least a component of the match rank value may be determined by comparing preferences specified by the supplier of the trip item to attributes of the new trip. As one non-limiting example, a supplier of a hotel trying to cultivate a romantic or family-friendly atmosphere may associate different values for trip types with which the trip item should be associated. The supplier may state, for example, that no weight should be provided for trips of a “business” type, while a weight of 25 should be provided for trips of a “romantic” type, and a weight of 50 should be provided for trips of a “family” type. In some embodiments, the trip item preferences may include a ranked list of trip types, wherein higher ranking trip types indicate a higher compatibility of the trip type to the item, and lower ranking trip types indicate a lower compatibility of the trip type to the item. In such an embodiment, a predetermined weight may be provided for each position on the ranked list, such that the supplier does not have to come up with their own weight values. An interface that presents each of the trip types in a ranked list and allows the supplier to reorder the list may be provided to help suppliers provide such rankings.

In some embodiments, at least a component of the match rank value may be determined by comparing attributes of the trip item to data retrieved from third-party sources using the trip information. For example, a trip item may include information describing favorable or unfavorable weather conditions. Examples of this information may include a golf trip item that indicates that sunny or cloudy weather are best suited for the trip item, while lightning storms will force the trip item to be canceled; a bowling alley trip item that indicates that rain or snow is well suited for the trip item due to the indoor nature of the activity; and/or the like. The match rank engine 206 may query a third-party information source that provides weather prediction information to determine a weather forecast on each day of the trip using the start date and end date of the trip, and may then calculate match rank values for the trip items to have a higher weight when a favorable weather prediction is indicated, and a lower weight when an unfavorable weather prediction is indicated. In such an embodiment, more than one match rank value may be calculated for each trip item to correspond with each weather prediction. In some embodiments, different weather types may be assigned to predefined “buckets,” each having a different predetermined weight, in order to help assist suppliers in providing such preferences. For example, an interface may present a “good bucket,” a “bad bucket,” and a “don't care” bucket. The interface may also present a variety of weather forecast types, such as “sunny,” “partly cloudy,” “mostly cloudy,” “overcast,” “precipitating,” and/or the like. The interface may allow the supplier to organize the weather forecast types between the good bucket, the bad bucket, and the don't care bucket, in order to efficiently assign weather preferences to the trip item. A predetermined weight may be assigned for each weather type associated with each bucket. In some embodiments, temperature ranges may also be specified and assigned to the buckets.

In some embodiments, at least a component of the match rank value may be determined by comparing a trip item seasonality attribute to the time period over which the trip is to take place. For example, an activity trip item that relates to an alpine skiing activity may include a seasonality attribute that indicates that the activity is best suited to the winter or early spring. As another example, an activity trip item that includes paddleboats on a lake may include a seasonality attribute that indicates that the activity is best suited to the summer (when the lake is unlikely to be frozen). A match of the seasonality attribute to the time period of the trip may cause the match rank value to be higher. In some embodiments, different seasons or periods of the year may also be assigned to buckets similar to the “good bucket,” “bad bucket,” and “don't care bucket” described above. The seasons or periods of the year may be broken into any suitable division (such as by month, by season, by date range, by proximity to a holiday (e.g., during Lent, Christmas, Diwali, Passover, Ramadan, and/or the like), and an interface may present the divisions to the supplier such that the divisions may be easily assigned to the buckets to indicate that the trip item is suitable, unsuitable, or indifferent to the specified season.

As will be understood by one of ordinary skill in the art, the particular values stated above for match rank value weights and the particular techniques for combining them are exemplary only and should not be seen as limiting. In some embodiments, different weights may be applied and/or different techniques may be used to combine the weights to create the match rank values.

Once the set of match rank trip items has been determined based on the calculated match rank values, the method 300 proceeds to block 332, where the traveler interface engine 202 presents the set of match rank trip items to the traveler for selection. After block 332, or if the result of the determination at decision block 320 was NO, the method 300 proceeds to a continuation terminal (“terminal C1”).

From terminal C1 (FIG. 3D), the method 300 proceeds to block 333, where the traveler interface engine 202 receives a selection of a set of trip items. In some embodiments, the selection of a set of trip items may be indicated by dragging and dropping trip items from a trip item tray as described below. In some embodiments, the trip items may be selected from lists of suggested items that were presented. In some embodiments, the selection of the set of trip items may be indicated in any other suitable manner. In some embodiments, the traveler interface engine 202 may check for one or more warning conditions, such as a match rank score beneath a predetermined threshold, an age restriction that would prevent one or more travelers associated with the trip from participating in the trip item, a determination of whether enough travel time has been allocated for travel between a location associated with the selected trip item and a location associated with a scheduled trip item, and/or any other condition that may be relevant to the scheduling of the trip item. If a warning condition is detected, the traveler interface engine 202 may present a warning before performing further processing of the selected trip items.

At block 334, the set of selected trip items is stored in association with the new trip in the trip data store 224. In some embodiments, the actions described with respect to blocks 333 and 334 may be optional, such as in cases where the traveler manually entered all trip items (or all trip items were imported from third-party trip data sources 218), and the traveler did not select any presented trip items. The overall method 300 may still be useful to such travelers for during-travel functionality described further below.

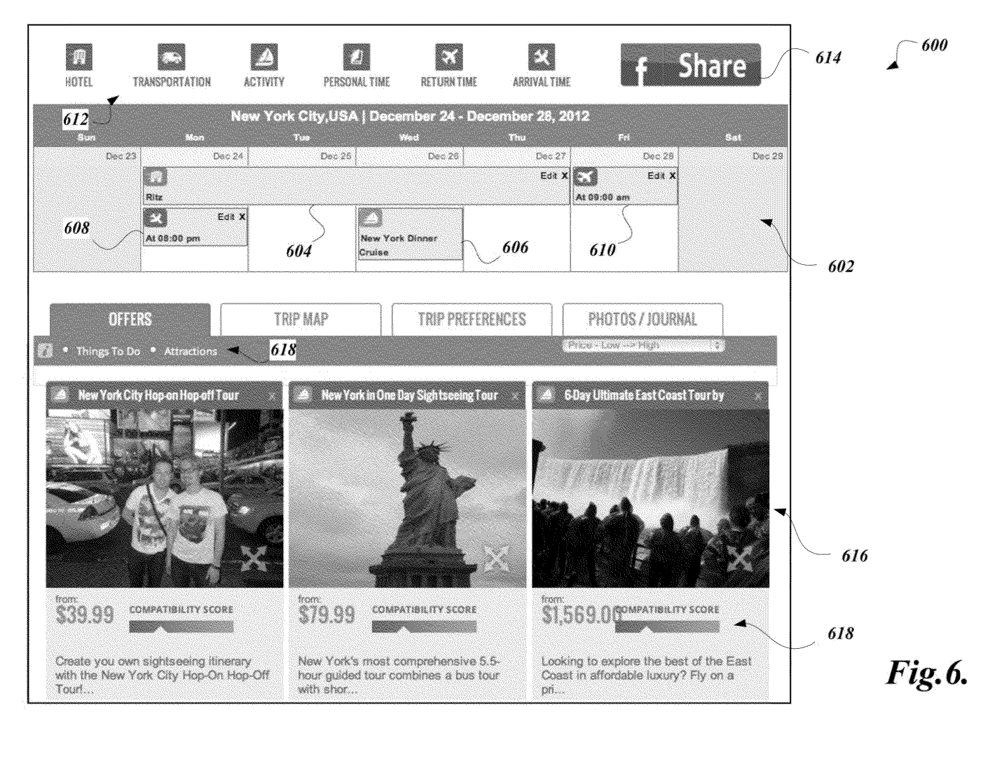

At block 336, the traveler interface engine 202 presents a calendar view to the traveler and accepts commands from the traveler to add, remove, or reschedule trip items. In some embodiments, the calendar view may be displayed while selections of trip items are being made to provide context for the selections and to provide a place for selected trip items to be dropped from trip item trays. FIG. 6, described further below, illustrates an exemplary embodiment of one such calendar view.

Once the traveler is satisfied with the trip items included within the new trip, the method 300 proceeds to block 338, where the traveler finalizes the new trip, and the trip planning system 200 processes reservations associated with the trip items. In some embodiments, finalizing the new trip may include actuating an interface element that indicates that the traveler is satisfied with the trip and wishes to confirm the trip schedule. In some embodiments, the processing of reservations may include indicating in the trip data store 224 and/or the trip item data store 226 which trip items have been included in the trip. In some embodiments, processing may also include using a booking engine 208 to communicate with one or more supplier information systems 216 to buy tickets, create reservations, or otherwise book scheduled trip items. The booking engine 208 may use payment account information stored in the traveler data store 230 to pay for bookings of trip items, or the supplier information systems 216 may follow up separately with the traveler to complete the transactions. Some trip items, such as visiting public parks, business meetings, and/or the like, may not include or require reservations.

The method 300 then proceeds to terminal D. From terminal D (FIG. 3A), the method 300 proceeds to a set of method steps 306 defined between a start terminal (“terminal E”) and an exit terminal (“terminal F”). The set of method steps 306 includes actions wherein one or more trip items are pushed to the traveler during travel upon detection of a push event.

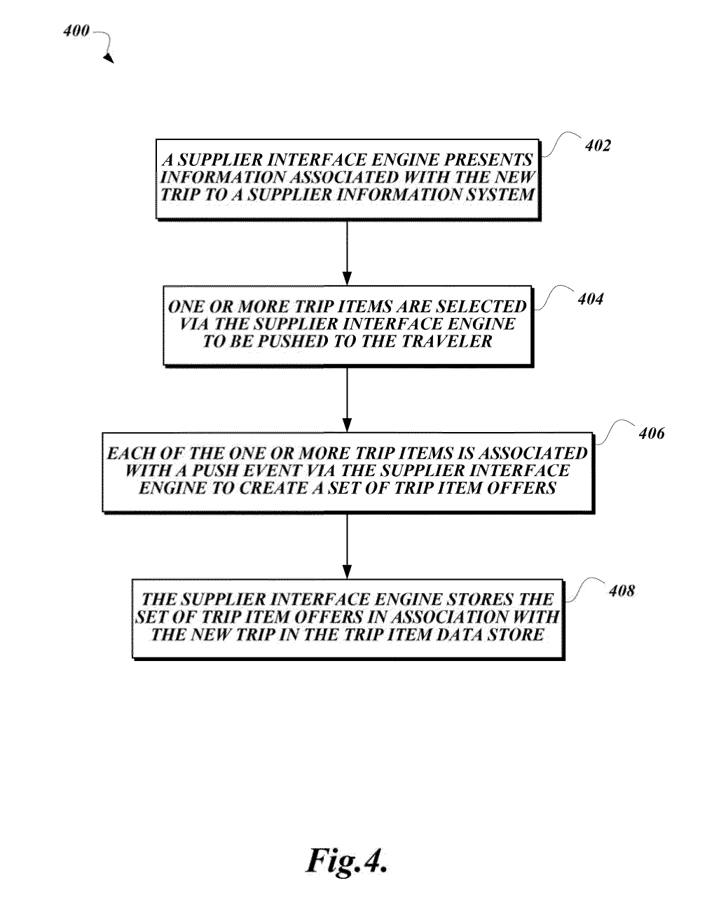

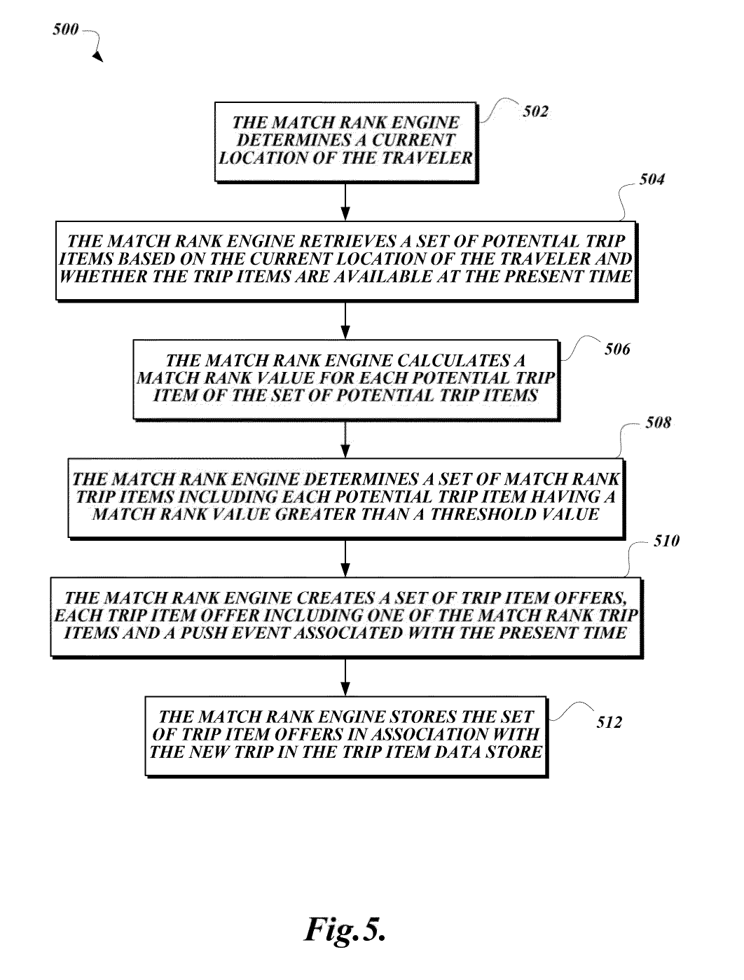

From terminal E (FIG. 3E), the method 300 proceeds to block 346, where a set of trip item offers are selected and transmitted to an offer push engine 204. As discussed further below with respect to FIGS. 4 and 5, the set of trip item offers may be selected automatically by the trip planning system 200, or may be selected by suppliers via an interface provided by the supplier interface engine 210. Once the offer push engine 204 receives the selected trip item offers, the method 300 proceeds to block 348, where the offer push engine 204 transmits the selected trip item offers to a traveler computing device, such as traveler desktop computing device 232, traveler mobile computing device 234, and/or the like, in response to detecting the events specified in the trip item offers. For example, if a push event associated with a trip item offer is a specific time, the event will be detected by the offer push engine 204 once the specific time is reached. As another example, if a push event associated with a trip item offer is a check-in at a location, the event will be detected by the offer push engine 204 once the traveler checks in at the location. As yet another example, if a push event associated with a trip item offer is an arrival within a geographic area, the event will be detected by the offer push engine 204 when a location of the user is detected to be within the geographic area, using a technique such as a GPS location of a traveler mobile computing device 234, a predicted location based on locations of scheduled trip items in the trip, or using any other suitable technique. Because the traveler is in the process of experiencing the trip at this point in the method 300, it is more likely that the selected trip item offers are transmitted to the traveler mobile computing device 234, but any suitable traveler computing device may be targeted. The trip item offers may be transmitted via SMS, email, push notifications to applications executed by the traveler mobile computing device 234, a telephone call to the traveler mobile computing device 234, and/or by any other suitable method. In some embodiments, if a traveler mobile computing device 234 is used to check in to a location, and the check-in is related to the push event, the trip item offer may be transmitted to the traveler mobile computing device 234 used to perform the check-in as part of the check-in process.

At block 350, the traveler computing device transmits a selection of one or more pushed trip items to the traveler interface engine 202 via an API, a selection on a presented interface, or via any other suitable technique, and the selected pushed trip items are added to the new trip. The method 300 then proceeds to terminal F, and from terminal F (FIG. 3A) to an end block, where the method 300 terminates.

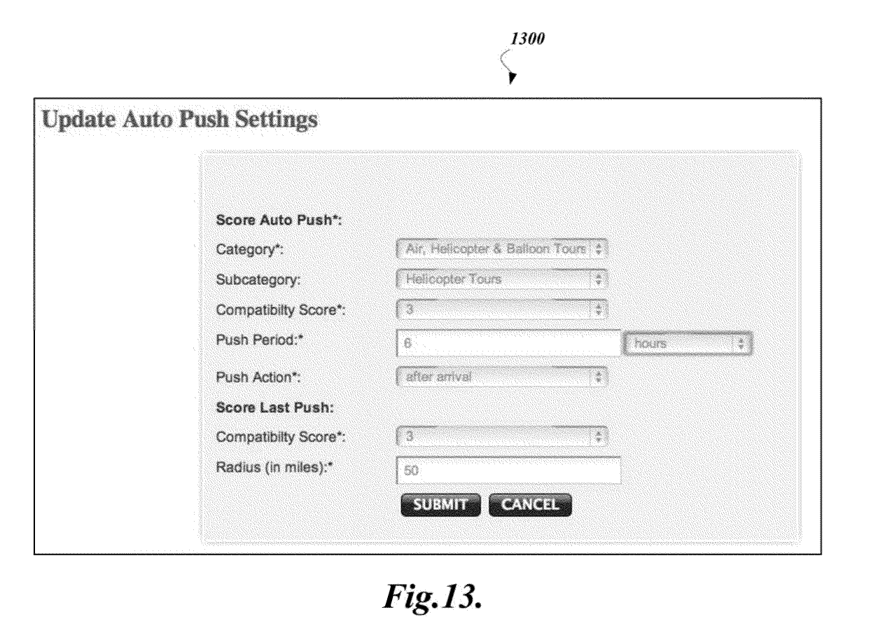

One of ordinary skill in the art will recognize that, in some embodiments, the set of method steps 306 between terminal E and terminal F may be repeated multiple times during a trip. For example, the set of method steps 306 may be repeated periodically at a predetermined time interval; may be repeated each time the traveler is predicted to be at a new location based on the scheduled trip items, and/or the like. In some embodiments, the set of method steps 306 may be executed with respect to a predetermined set of trip items, categories of trip items, or subcategories of trip items, such that trips meeting a match rank threshold with respect to the predetermined set of trip items are chosen to have trip item offers pushed to them (as opposed to having trip item offers chosen for trips). In such embodiments, the set of method steps 306 may be executed on a schedule associated with the predetermined set of trip items, a category of trip items, a subcategory of trip items, a supplier, or in response to a global setting. FIG. 13, discussed further below, illustrates an exemplary embodiment of an interface suitable for establishing such settings according to various aspects of the present disclosure. One of ordinary skill in the art will also recognize that, in some embodiments, the overall method 300 may be repeated sequentially multiple times for multiple trips, or may be performed in parallel for more than one traveler and/or more than one trip at a time.

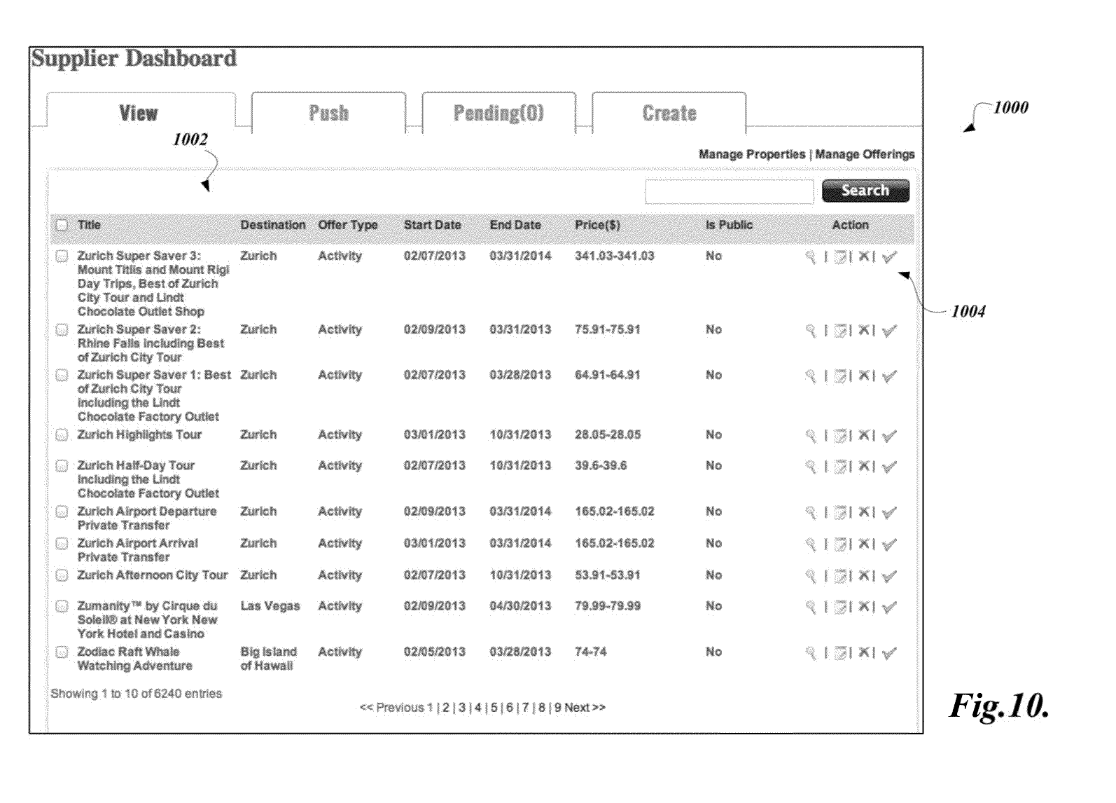

FIG. 4 is a flowchart that illustrates an exemplary embodiment of a procedure 400 suitable for use for selecting trip item offers to be pushed to a traveler computing device, as discussed above with regard to block 346 in FIG. 3E. In the procedure 400, selected trip item offers are received from a supplier. Examples of interfaces suitable for use in the procedure 400 are illustrated in FIGS. 10-12, though other interfaces may be used instead.

At block 402, a supplier interface engine 210 presents information associated with the new trip to a supplier information system 216. In some embodiments, the information includes information useful for the supplier to decide which trip items would be appropriate for pushing, such as trip dates, predicted locations, numbers and ages of travelers, desired hotel star ratings, categories of activities or events booked, and/or the like. Match rank value information for each trip with respect to trip items provided by the supplier may also be presented. In some embodiments, the supplier may be presented with information for all travelers who are currently checked-in in the vicinity of a location associated with their trip items on a map. Upon selecting a traveler, the supplier may be presented with a trail of the traveler's check-ins, along with descriptions of the other locations at which the traveler has checked in. The supplier information system 216 may include any computing device (or devices) suitable for presenting the information to the supplier and receiving the supplier's selections. For example, in some embodiments, the supplier information system 216 may include a computing device configured to access an interface presented by the supplier interface engine 210. In other embodiments, the supplier information system 216 may be a computing device that receives information via an API provided by the supplier interface engine 210 for an automated trip selection process, or so that the supplier information system 216 may present its own interface using the received information.

Next, at block 404, one or more trip items are selected via the supplier interface engine 210 to be pushed to the traveler. At block 406, each of the one or more trip items is associated with a push event via the supplier interface engine 210 to create a set of trip item offers. As discussed above, a trip item offer includes an association between a trip item and a push event, and may also include additional information. As described above, the actions described in both blocks 404 and 406 may be performed via an interface presented by the supplier interface engine 210, may be performed via an API provided by the supplier interface engine 210, or by any other suitable technique. At block 408, the supplier interface engine 210 stores the set of trip item offers in association with the new trip in the trip item data store 226, and the procedure 400 for selecting trip item offers to be pushed to a traveler computing device is complete.

FIG. 5 is a flowchart that illustrates an exemplary embodiment of another procedure 500 suitable for use for selecting trip item offers to be pushed to a traveler computing device, as discussed above with respect to block 346 in FIG. 3E. In the procedure 500, trip item offers are selected automatically by the trip planning system 200. At block 502, the match rank engine 206 determines a current location of the traveler. As with determining when a location-based push event occurs, the current location of the traveler may be determined based on locations associated with scheduled trip items, may be based on check-ins, may be based on a location of a traveler mobile computing device 234 detected via GPS or other positioning technology, or by any other suitable technique. Next, at block 504, the match rank engine 206 retrieves a set of potential trip items based on the current location of the traveler and whether the trip items are available at the present time. Availability may be determined based on attributes of each trip item, such as whether the attraction or event is open on that day or at that time, whether all travelers associated with the trip are eligible to attend the event due to age restrictions, the availability of tickets or reservations (which may be obtained from a third-party data source), and/or the like.

The procedure 500 then proceeds to block 506, wherein the match rank engine 206 calculates a match rank value for each potential trip item of the set of potential trip items. The match rank value may be determined by the match rank engine 206 using a technique similar to those discussed above with respect to block 330 of FIG. 3C. At block 508, the match rank engine 206 determines a set of match rank trip items including each potential trip item having a match rank value greater than a threshold value. The threshold value may be a system-wide setting, may be configurable by the traveler as part of the trip preferences, may be configurable by suppliers providing the trip item information, and/or may be any other suitable value. Next, at block 510, the match rank engine 206 creates a set of trip item offers, each trip item offer including one of the match rank trip items and a push event associated with the present time. At block 512, the match rank engine 206 stores the set of trip item offers in association with the new trip in the trip item data store 226, and the procedure 500 for selecting trip item offers to be pushed to a traveler computing device is complete.

The discussion of procedure 500 relates to trip items available at the present time, but in some embodiments, a similar procedure could be used to select trip items to be pushed at one or more future times, or in association with one or more future locations. In such an embodiment, an appropriate push event would be created instead of the push event for the present time described above in block 510.

Traveler Interface Examples

FIGS. 6-9 illustrate exemplary interfaces presented to travelers by the trip planning system 200 according to various aspects of the present disclosure. As will be appreciated by one skilled in the art, the illustrated traveler interfaces are shown without context, but unless explicitly stated otherwise, could be presented by a standard web browser, within a stand-alone application, by an app executed by a mobile computing device, and/or by any other suitable technique. The traveler interfaces may be presented using any suitable technology, including but not limited to native graphics routines, DirectX, OpenGL, HTML, CSS, JavaScript, AJAX, Objective-C, and/or any other suitable interface display technique, and may be configured to display information as well as accept input. While some interface elements are described below, other interface elements well known in the art may be illustrated but are not described. Such interface elements have the functionality as would be understood by one of ordinary skill in the art, and are therefore not further described below for sake of discussion. Further, the exemplary interfaces may be simplified for ease of illustration and discussion. In some embodiments, embodiments of the disclosed interfaces may include additional functionality and/or functionality that is well known in the arts of interface design and implementation. Such functionality is not further described herein for ease of discussion.

The interfaces are described as being presented by the traveler interface engine 202. In some embodiments, presenting an interface includes an interface that is generated by a server computing device associated with the trip planning system 200 and is transmitted to a traveler computing device for rendering and display to the traveler. In other embodiments, portions of the interface generation may be performed by the traveler computing device, and/or portions of the interface rendering and display may be performed by the computing device associated with the trip planning system 200. Those of ordinary skill in the art will recognize that other techniques may be used to generate, display, or otherwise present the interfaces to the traveler without departing from the scope of the present disclosure.

FIG. 6 illustrates an exemplary trip planning interface 600 presented by the traveler interface engine 202 according to various aspects of the present disclosure. The illustrated trip planning interface 600 includes a calendar interface 602 and a trip item tray 616, as described above. The calendar interface 602 presents a time period relevant to a trip being planned via the trip planning interface 600. The calendar interface 602 displays various trip items that have been scheduled for the trip. For example, a hotel reservation trip item 604 is displayed, spanning from Monday to Thursday. An arriving flight trip item 608 is displayed on Monday at 8:00 PM, and a departing flight trip item 610 is displayed on Friday at 9:00 AM. An activity trip item 606 is displayed on Wednesday. For each trip item, an “edit” link allows the traveler to change configurable attributes of the trip item (such as the time, various trip item add-ons, and/or the like), and an “X” link allows the traveler to remove the trip item from the trip. Different types of trip items, such as hotels, flights, activities, and/or the like may be distinguished with different colors, different icons, and/or the like. The calendar interface 602 may also present further information associated with the displayed time period but not illustrated in the FIGURE, such as weather forecast information for each day, holidays, and/or the like. In some embodiments, the calendar interface 602 may order trip items on given days vertically based on timing, for trip items associated with particular times of day. In some embodiments, the calendar interface 602 may occupy a larger vertical proportion of the interface as a whole, thus allowing the calendar interface 602 to display individual time slots within each day in which trip items may be scheduled.

The trip item tray 616 presents a set of trip items that may be added to the trip. As discussed above, the trip items in the trip item tray 616 may reflect trip items determined to have a high match rank score, and are therefore predicted to be desirable to the traveler. As illustrated, the match rank score for each of the trip items is shown on a compatibility score scale 618, though in some embodiments, a numerical match rank score may be displayed, or the match rank score may be hidden from view. The trip item tray 616 may also include one or more filter settings 618 which may be used by the traveler to filter the trip items presented by the trip item tray 616 based on one or more attributes of the trip items.

In some embodiments, the traveler may drag a trip item from the trip item tray 616 to the calendar interface 602 in order to add the trip item to the trip. The calendar interface 602 may allow dropping of the trip item at any point on the calendar, or may only allow the trip item to be dropped onto days or times on the calendar at which the trip item would not conflict with other, already scheduled trip items. For example, a trip item may be associated with a visit to a museum that is closed on Tuesdays. If a traveler attempted to drag this trip item from the trip item tray 616 to the calendar interface 602, the traveler would be prevented from dropping the trip item onto a Tuesday. As another example, the time and location of scheduled trip items may be compared to the location and proposed time of a trip item to be dropped on the calendar interface 602, and the drop may be prevented (or a warning displayed) if the traveler interface engine 202 determines that it would not be possible to arrive at the location of the dropped trip item after the conclusion of the scheduled trip item. In some embodiments, once a trip item is grabbed from the trip item tray 616 to be dragged and dropped onto the calendar interface 602, the appearance of the calendar interface 602 and/or the trip item may be altered to indicate valid locations on the calendar interface 602 at which the trip item may be dropped. As illustrated, some trip items may be time-exclusive, while some trip items may allow overlap. For example, the hotel reservation trip item 604 may be configured to allow other trip items to be planned at the same time (such as the activity trip item 606). Meanwhile, the activity trip item 606 may not allow other time-exclusive trip items, such as another activity trip item, to be scheduled at an overlapping time.

The trip planning interface 600 also includes a set of manual activity entry interface elements 612 and a share interface element 614. Upon actuating one of the manual activity entry interface elements 612 (or dragging one of the manual activity entry interface elements 612 to the calendar interface 602), the trip planning interface 600 presents a form for accepting entry of information regarding a manually added trip item, such as a hotel reservation, a flight, and/or the like, that was reserved using a different service (or that does not require booking but was otherwise planned outside of the trip planning system 200). The share interface element 614 may be configured to, upon actuation, cause a form to be presented that allows the traveler to share information regarding the trip with one or more social media services.

In some embodiments, multiple trip item trays may be available, either displayed at the same time or sequentially upon selection by the traveler. For example, in addition to a trip item tray 616 that presents trip items recommended by the match rank engine 206, the trip planning interface 600 may include a favorite trip item tray or a social recommendation trip item tray (not illustrated). The favorite trip item tray may accept trip items that are dragged and dropped into the tray from the trip item tray 616 or the calendar interface 602. Trip items dropped in the favorite trip items tray may be saved in association with the trip in the trip data store 224, but are not yet scheduled for the trip. Trip items displayed in the favorite trip items tray may later be dragged onto the calendar interface 602 for scheduling, or may be removed from the favorite trip items tray without scheduling. The favorite trip items tray may provide a convenient way to save trip items for later consideration. The social recommendation trip item tray may include a set of trip items recommended by users of a social media service provider 220 with whom trip information had been shared, as described above.

The trip planning interface 600 includes a set of tabs for switching between different non-calendar functionality. The tab displayed in FIG. 6 is the “offers” tab, which is configured to present a trip item tray 616 including a set of trip item offers. Also illustrated are a “trip map” tab, a “trip preferences” tab, and a “photos/journal” tab.

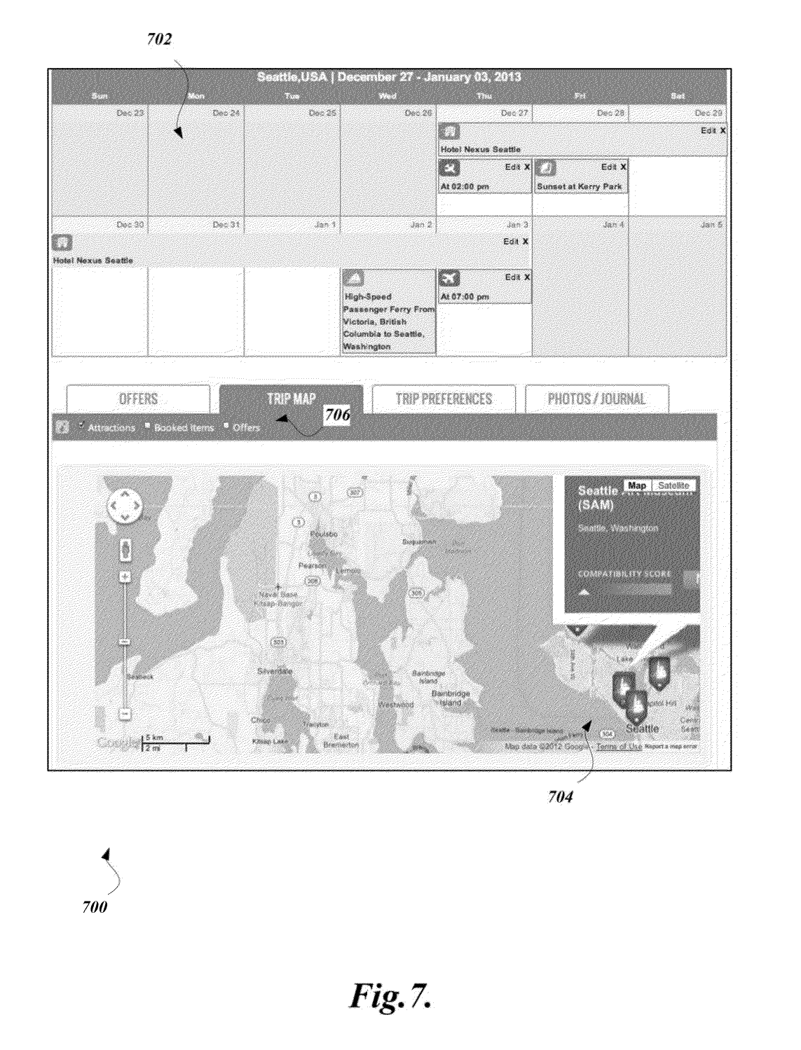

FIG. 7 illustrates an exemplary trip planning interface 700 presented by the traveler interface engine 202 upon selecting a “trip map” tab, according to various aspects of the present disclosure. A calendar interface 702 similar to the calendar interface 602 discussed above remains, but the trip item tray has been replaced with a map interface 704. The map interface 704 includes a set of indicators showing the locations of scheduled trip items. The map interface 704 may also show a set of indicators for trip item offers or other unscheduled trip items, such that the traveler may browse for trip items by location, and may drag unscheduled trip items from the map interface 704 to the calendar interface 702 to schedule the dragged unscheduled trip items similar to the drag-and-drop functionality discussed above with respect to FIG. 6.

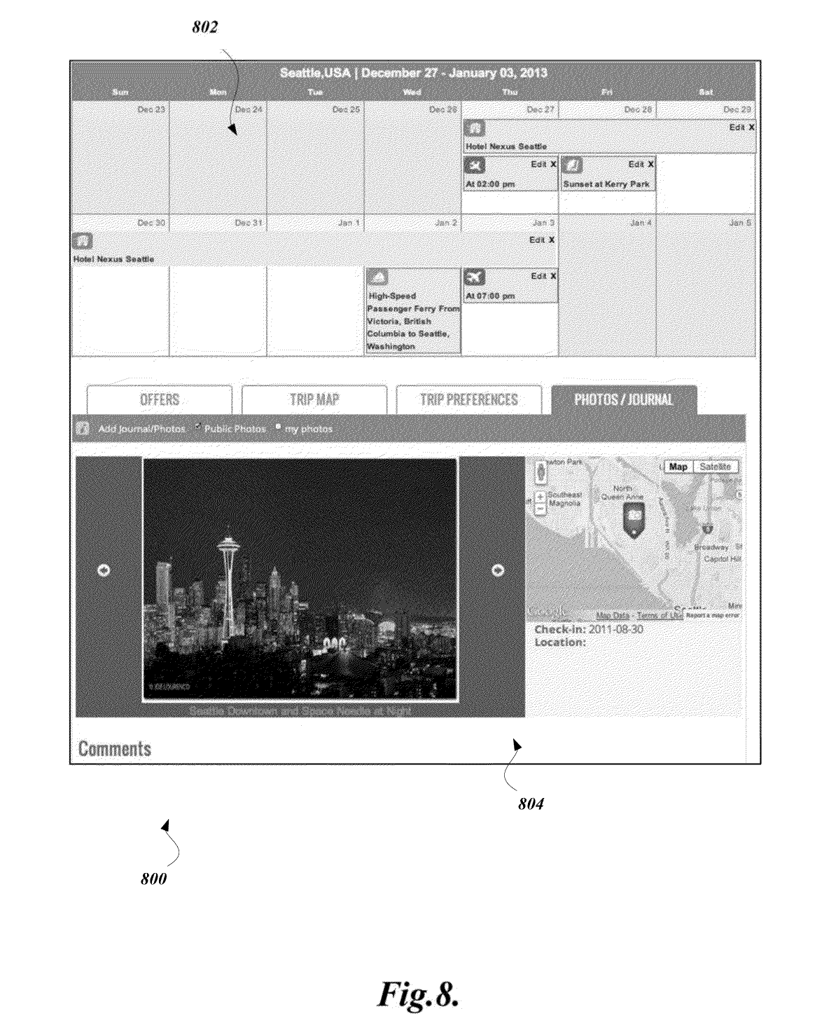

FIG. 8 illustrates an exemplary trip planning interface 800 presented by the traveler interface engine 202 upon selecting a “photos/journal” tab, according to various aspects of the present disclosure. A calendar interface 802 similar to the calendar interface 602 discussed above remains, and the trip item tray has been replaced with a journaling interface 804. The journaling interface 804 includes a map that shows check-ins associated with the trip, as well as pictures and/or comments entered by the traveler. In some embodiments, the journaling interface 804 may aggregate posts from social media service providers 220 that are tagged or otherwise associated with the trip. In some embodiments, the journaling interface 804 may provide an input form for the traveler to input journal entries. In such an embodiment, the traveler may select one or more trip items from the calendar interface 602, which may then cause an input form for a journal entry to be associated with the one or more trip items to be displayed. In some embodiments, navigation within the journaling interface 804 may include next and/or previous buttons, and may include interaction with the calendar interface 802 or map. In other words, selecting a trip item, a day, or a time from the calendar interface 802 or a location from the map may cause the journaling interface 804 to present journal entries or associated media that are relevant to the selected trip item, day, time, or map location/check-in. The associated media may include media posted by the traveler for trip items that have already taken place, and may include media posted by third parties and gathered by the journaling interface 804, such as promotional photos, social media profile photos, and/or the like, to assist in future trip visualization.

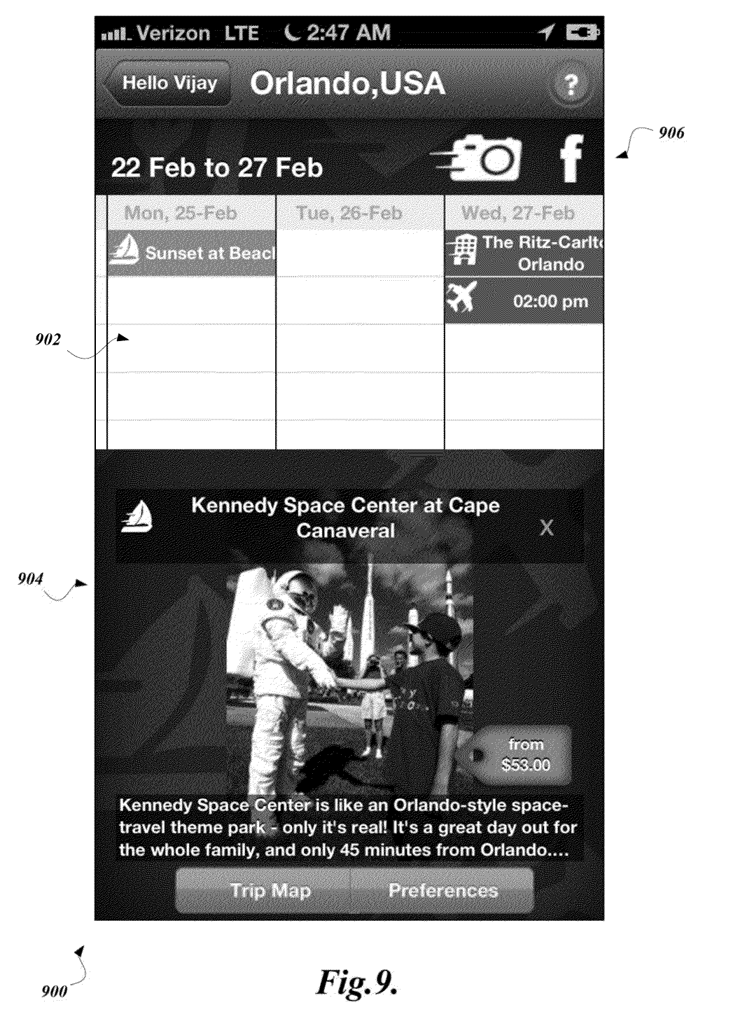

FIG. 9 illustrates an exemplary trip planning interface 900 having functionality similar to the functionality of trip planning interface 700 illustrated in FIG. 6, but adapted for display by a traveler mobile computing device 234 such as a smartphone, a tablet computing device, and/or the like. The trip planning interface 900 includes a calendar interface 902, a trip item tray 904, and a share interface element 906 which may have functionality similar to the calendar interface 602, the trip item tray 616, and the share interface element 614 discussed above. In some embodiments, the elements of the trip planning interface 900 may be adapted for use within a touch-enabled interface. For example, the trip item tray 904 is illustrated as presenting a single trip item, but other trip items in the trip item tray 904 may be presented by swiping left or right on the displayed trip item. As another example, instead of dragging-and-dropping items from the trip item tray 904, a touch-optimized version of the trip planning interface 900 may accept a tap on a date in the calendar interface 902, and may then present one or more offers relevant to that date for selection by the traveler.

Certain aspects of the trip planning interface 900 presented by a traveler mobile computing device 234 may be hidden from view. For example, the trip planning interface 900 may access current location information provided by the traveler mobile computing device 234, and may provide the current location information to the traveler interface engine 202 to supplement the information stored by the system 200 about the traveler. The current location information may be used by the traveler interface engine 202 to determine trip items or trip item offers to be presented to the user, may be used to determine a destination city when creating a trip, and/or the like. The currently location information may also be used by the system 200 to help determine a local expert, local service provider, local concierge desk, and/or the like that helped the traveler sign up for an account with the system 200, helped create a trip, or helped book one or more trip items. In some embodiments, the currently location information may be used by the traveler interface engine 202 to determine which suppliers (e.g., suppliers within a predetermined radius of the current location) are allowed to push trip item offers to the traveler.

Supplier Interface Examples

FIGS. 10-13 illustrate exemplary interfaces presented to suppliers by the trip planning system 200 according to various aspects of the present disclosure. As with the traveler interface examples described above, the illustrated supplier interfaces are shown without context, but unless explicitly stated otherwise, could be presented by a standard web browser, within a stand-alone application, by an app executed by a mobile computing device, and/or by any other suitable technique. The supplier interfaces may be presented using any suitable technology, including but not limited to native graphics routines, DirectX, OpenGL, HTML, CSS, JavaScript, AJAX, Objective-C, and/or any other suitable interface display technique, and may be configured to display information as well as accept input. While some interface elements are described below, other interface elements well known in the art may be illustrated but are not described. Such interface elements have the functionality as would be understood by one of ordinary skill in the art, and are therefore not further described below for sake of discussion. Further, the exemplary interfaces may be simplified for ease of illustration and discussion. In some embodiments, embodiments of the disclosed interfaces may include additional functionality and/or functionality that is well known in the arts of interface design and implementation. Such functionality is not further described herein for ease of discussion.

The interfaces are described as being presented by the supplier interface engine 210. In some embodiments, presenting an interface includes an interface that is generated by a server computing device associated with the trip planning system 200 and is transmitted to a supplier information system 216 for rendering and display to the supplier. In other embodiments, portions of the interface generation may be performed by the supplier information system 216, and/or portions of the interface rendering and display may be performed by the computing device associated with the trip planning system 200. Those of ordinary skill in the art will recognize that other techniques may be used to generate, display, or otherwise present the interfaces to the supplier without departing from the scope of the present disclosure.

FIG. 10 illustrates a view portion 1000 of an exemplary supplier dashboard interface presented by the supplier interface engine 210 according to various aspects of the present disclosure. The supplier dashboard interface is configured to allow a supplier to view, add, edit, and delete trip items managed by or otherwise associated with the supplier. The supplier dashboard interface may also be configured to allow the supplier to push selected trip items to travelers. A list of trip items 1002 managed by the supplier is presented by the view portion 1000 of the supplier dashboard interface. The list of trip items 1002 presents information for each trip item including a title, an associated destination or location, a trip item type, a start date on which the trip item becomes valid, an end date on which the trip item is no longer valid, a price or price range for the trip item, and an indication of whether or not the trip item is public. For each trip item, a set of trip item controls 1004 is displayed. The set of trip item controls 1004 allow the supplier to view, edit, delete, or approve an associated trip item to make the associated trip item public. A set of checkboxes allows one or more trip items to be selected for pushing to travelers, as discussed further below.

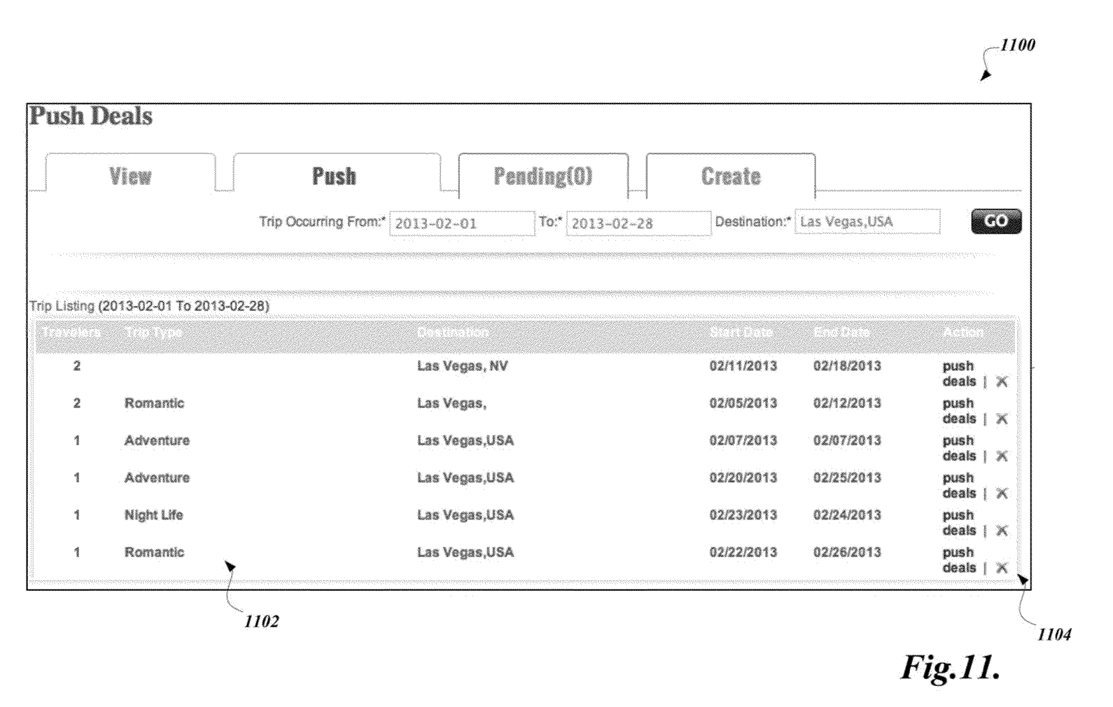

FIG. 11 illustrates a push portion 1100 of an exemplary supplier dashboard interface presented by the supplier interface engine 210 according to various aspects of the present disclosure. A list of trips 1102 is presented by the push portion 1100 of the supplier dashboard interface. The list of trips 1102 is retrieved from the trip data store 224 by the supplier interface engine 210, and may include one or more trips the supplier interface engine 210 determines that may be relevant to trip items offered by the supplier based on a match rank calculation, a location, or by any other suitable technique. The information about each trip made available to the supplier may be limited to the anonymous number of travelers, trip type, destination, start date, and end date illustrated in the list of trips 1102, or may allow the supplier to view further detailed information about the trip including scheduled trip items that are already part of the trip. Each presented trip in the list of trips 1102 includes a set of trip controls 1104. The set of trip controls 1104 for each trip includes a push deals interface control and a remove trip interface control. The remove trip interface control, symbolized by an “X,” removes the associated trip from the list of trips 1102. The push deals interface control, symbolized by the text “push deals,” causes any deals for which the associated checkbox in the view portion 1000 was selected to be included in a deal pushing dialog for the trip, as illustrated and described below. The list of trips 1102 is only an exemplary embodiment of a presentation of trips by the supplier dashboard interface. In some embodiments, a map view may be presented to the supplier, on which current location information associated with one or more travelers and/or one or more trips may be presented. The supplier may select trips to which trip item offers should be pushed by selecting the trips from the map view, and/or may be able to establish a geographic area for which trip offers will be automatically pushed to travelers with current locations within the geographic area if a match rank value meets a predetermined threshold.

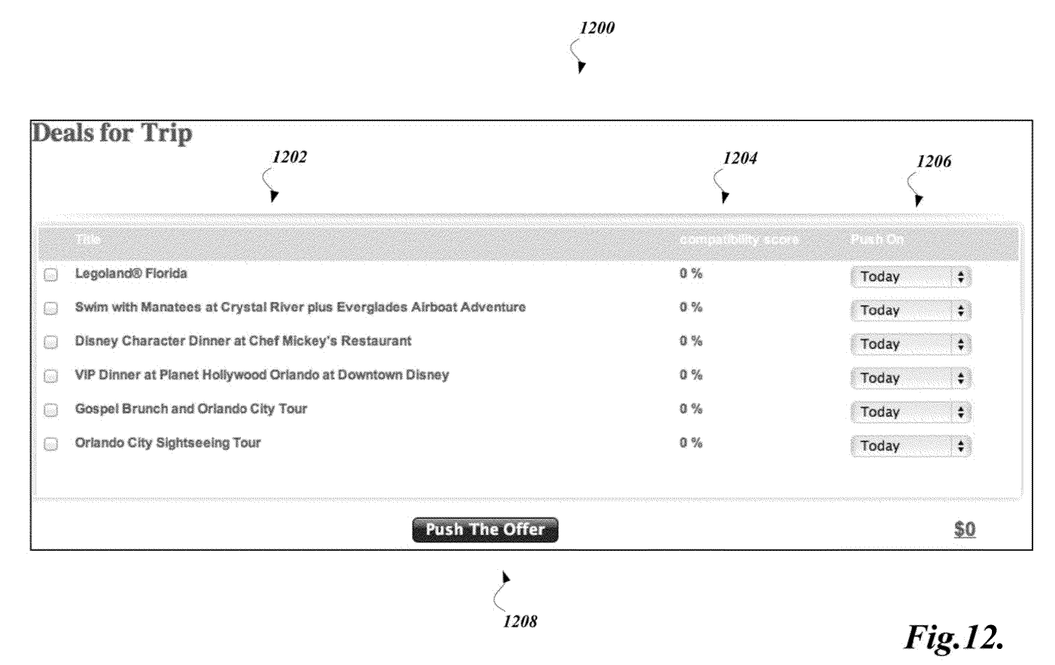

FIG. 12 illustrates a deal pushing dialog 1200 of an exemplary supplier dashboard interface presented by the supplier interface engine 210 according to various aspects of the present disclosure. Once a set of checkboxes are selected in the view portion 1000 of the supplier dashboard interface and a push deals interface control is actuated in the push portion 1100 of the supplier dashboard interface, the selected trip items are displayed in the deal pushing dialog 1200. A checkbox, a trip item name 1202, a match rank value 1204, and a push event setting 1206 are available for each trip item. The supplier may use the match rank value 1204, computed by the match rank engine 206 as discussed above, to determine which of the trip items selected earlier should be pushed to the traveler as trip item offers. The push event setting 1206 allows the supplier to specify an event, such as a time, a location, a check-in to a particular trip item or venue, arrival in a geographic radius, and/or the like, to cause the trip item to be pushed to the traveler. In some embodiments, a selection of one or more expiration events associated with each trip item may also be available. An offer push interface element 1208, upon actuation, causes trip item offers to be created for any selected trip items and associated push event settings 1206, which are transmitted by the supplier interface engine 210 to the offer push engine 204 to be pushed to a traveler computing device.

FIG. 13 illustrates an exemplary embodiment of an interface 1300 suitable for establishing auto-push settings as discussed above with respect to method 300, according to various aspects of the present disclosure. Among other things, the interface 1300 may allow a supplier to specify a category and subcategory, and then to have a compatibility score or a weight contribution to a match rank value automatically be assigned based on the category and subcategory. The push period may be set to a configurable number of hours, minutes, days, or any other suitable time period. A push action, such as after arrival, upon departure, and/or the like may also be specified to help create the push event to be associated with a created trip item offer. A score may also be assigned for a last push based on a given radius from a location associated with a trip item.

Although not illustrated, in some embodiments, a supplier dashboard interface may be configured to detect traveler check-ins at a given location, or within a predetermined radius of a given location. Notifications of such check-ins may be proactively transmitted to the supplier using any suitable technique for bringing the notification to the supplier's attention. The supplier may then access other portions of the supplier dashboard interface to address the notification and push relevant offers to the traveler, if desired. In some embodiments, such notifications may only be transmitted to the supplier for travelers, trips, or trip items that have a match rank value that meets a threshold value.

Alternative Interface Embodiments

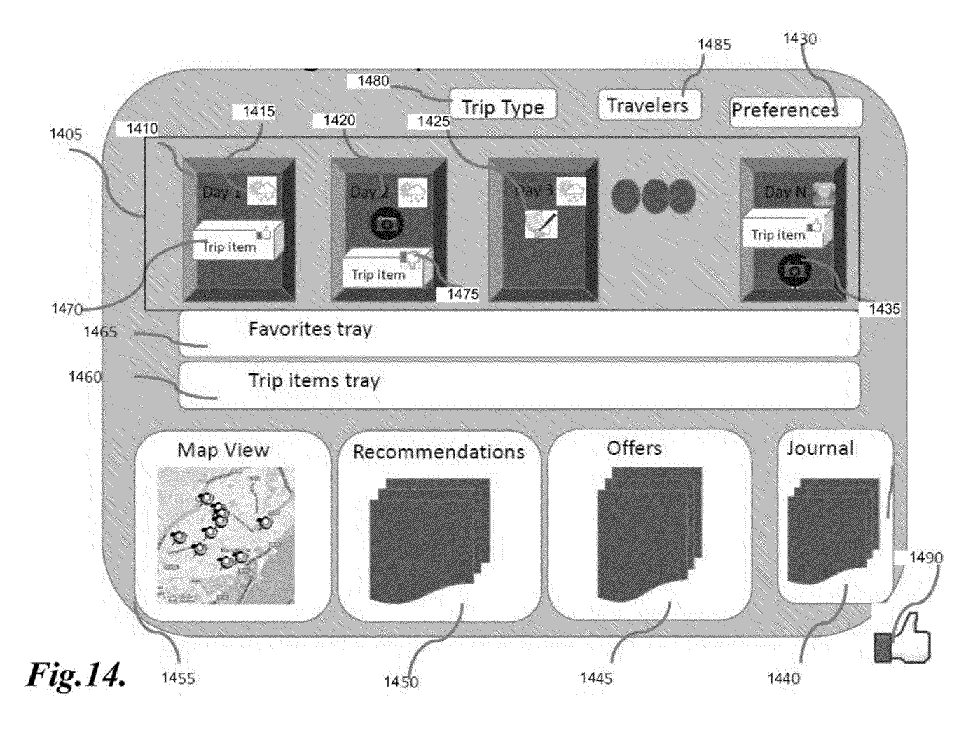

FIGS. 14-24 illustrate various alternative embodiments of interfaces described above. Though the appearance of the interfaces illustrated in FIGS. 14-24 may be different from the appearance of the interfaces described above, in some embodiments, the functionality is substantially similar unless explicitly stated to the contrary.

FIG. 14 shows an exemplary embodiment of a trip calendar user interface (“UI”), similar to the interface illustrated in FIG. 6, according to various aspects of the present disclosure. In various embodiments, trip calendar UI provides a calendar interface 1405 displaying the days included in a trip. Each day of the trip is presented by a trip day item, e.g., 1410. In various embodiments, a trip day item may include a weather icon 1415 displaying the weather forecast for that particular day to help a traveler in making decisions about things to do on that day of the trip and day and date 1420 of the trip day item, a link 1425 to a journal entry if the trip has been completed or is in progress and the user has “checked-in” somewhere and entered a journal entry, and the like. In some embodiments, a journal entry could be accompanied by a photograph or a video represented by a media link 1435, name of a well known place, an address, latitude/longitude, a caption, a text description, or the like.

Trip calendar UI may include a preferences link 1430 to a preferences section where trip preferences may be collected, a trip type 1480 as stated by the traveler (e.g., family outing, business trip, honeymoon, adventure, family visit, and the like), a travelers link 1485 which links to information about the travelers (e.g., names, whether they are adults, children, seniors or infants, and the like). Item 1470 represents an exemplary trip item. In some embodiments, a trip item may have an indicator of its status, such as whether it was imported from an external system, created manually, purchased, or pending.

In some embodiments, a traveler may add trip items to a trip day item or to a “favorites tray” 1465. A traveler may also move trip items between favorites tray 1465 and the trip day items in calendar interface 1405. Thus, trip calendar UI allows a traveler to experiment with a combination of trip items and find the trip that fits their needs.

In some embodiments, a traveler may create trip items from scratch in trip items tray 1460. Trip items created from trip items tray 1460 are not imported or pushed offers. The trip items tray 1460 provides a variety of draggable and droppable icons that can be added to the calendar interface 1405 or favorites tray 1465. In some embodiments, icons included in the trip items tray 1460 represent various types of trip item—flight, transportation, activities, events, lodging, attractions, and the like. Typically, when a traveler adds a trip item using an icon in trip items tray 1460, the details of the trip item are entered by the traveler. In some embodiments, the interface provides suggestions wherever possible. For examples, suggestions may include names of hotels and their addresses, flight carriers and flight numbers, car rental agencies and their addresses, and the like. Similar functionality may be associated with the icons at the top of the interface illustrated in FIG. 6.

In some embodiments, trip calendar UI may also include a map view 1455 of all the trip items included in a trip such as trip items that are imported, created from trip items tray 1460, purchased, or pending and offers that have been pushed to the traveler. The trip items may be categorized by the type of the trip item (e.g., flight, transport, activities, events, lodging, attractions, and the like). They may also have a status associated with them as described earlier. In some embodiments, a traveler may filter trip items shown on map view 1455 based on the trip item type.

In some embodiments, trip calendar UI may also include a recommendations link 1450 that represent the recommendations for the trip from social media circles. A traveler can share a trip with others, who may choose to “like” or “dislike” a particular trip item (e.g., using control 1475) or an entire trip (e.g., using control 1490). The data collected by this feature may also be used by the trip calendar backend system to store preferences and to compute match ranks.

In some embodiments, trip calendar UI may also include an offers link 1445 that represents the offers that have been pushed to a traveler by suppliers. In some embodiments, trip calendar UI may also include a journal link 1440 that represents the journal entries made by the traveler during or after the trip for sharing with others. One or more journal entries may be associated with a trip item, a trip day item, or the entire trip.

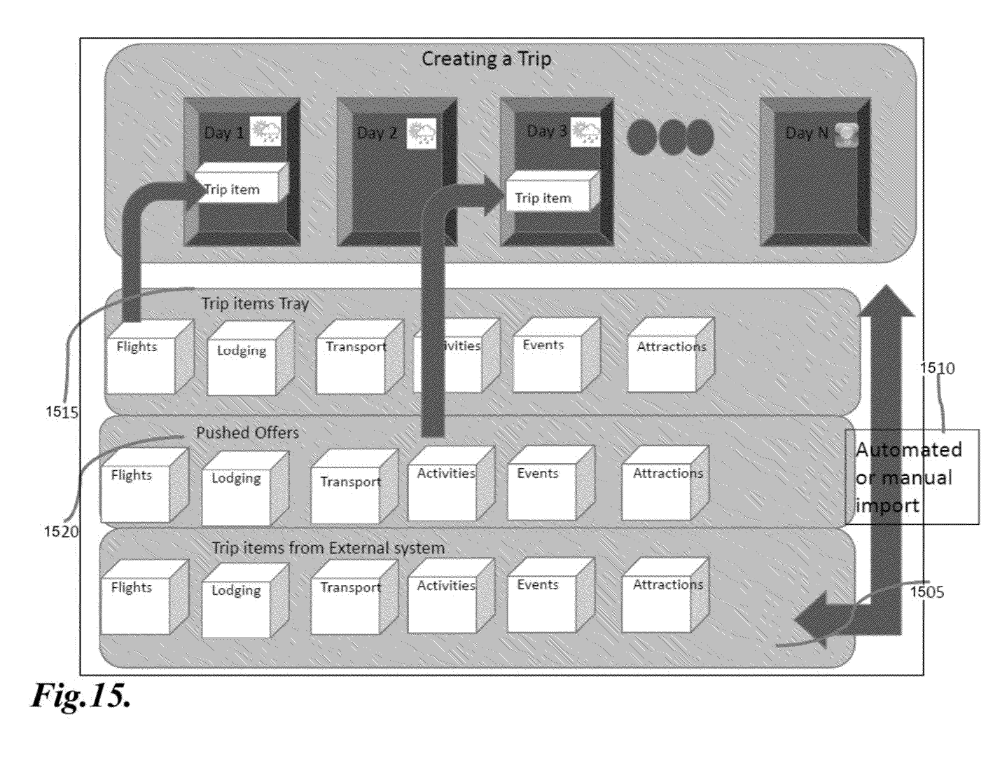

FIG. 15 illustrates an exemplary interface that shows the creation of trip items, in accordance with various aspects of the present disclosure. In some embodiments, trip items can be created from trip items tray 1515, selected from pushed offers 1520, or imported from an external system 1505 via manual or automated processes 1510 and added to a trip item.

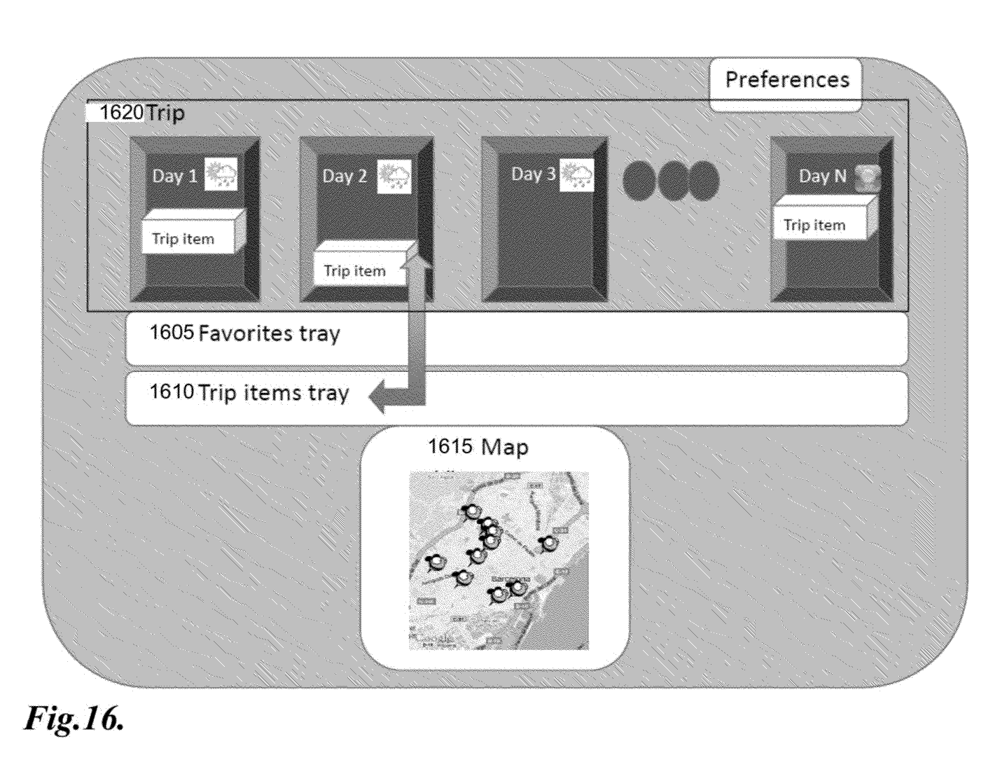

FIG. 16 illustrates an exemplary interface that shows a trip calendar in the conception phase of trip planning, in accordance with various aspects of the present disclosure. At this state, there are no pushed offers or booked or imported items. Trip calendar provides a visualized way to explore different options for a trip by allowing travelers to select trip items from trip items tray 410 and place them in the itinerary displayed in calendar interface 1620, move trip items from the calendar interface 1620 to favorites tray 1605, or vice versa. As described above, in some embodiments, trip calendar contains a map view 1615 that shows trip items added to the trip on a map.

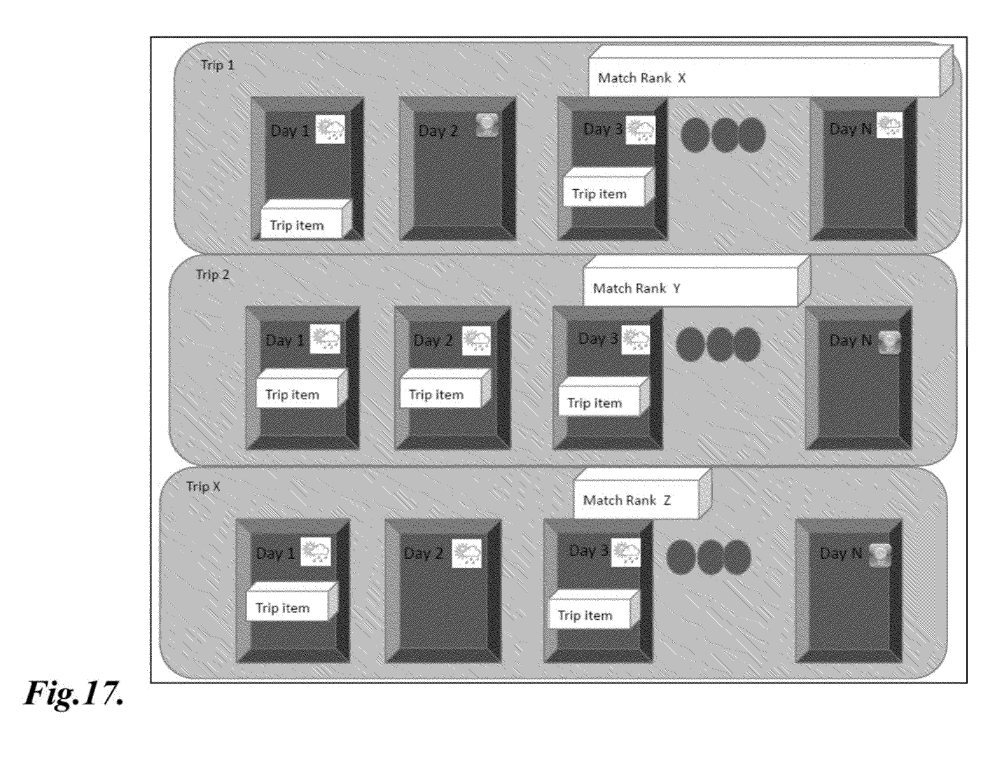

FIG. 17 illustrates an exemplary interface that presents a list of trips by date along with information about what has been scheduled for each trip, according to various aspects of the present disclosure. Such an interface may be suitable for presentation to a supplier in order to pick trips to which trip item offers should be pushed.

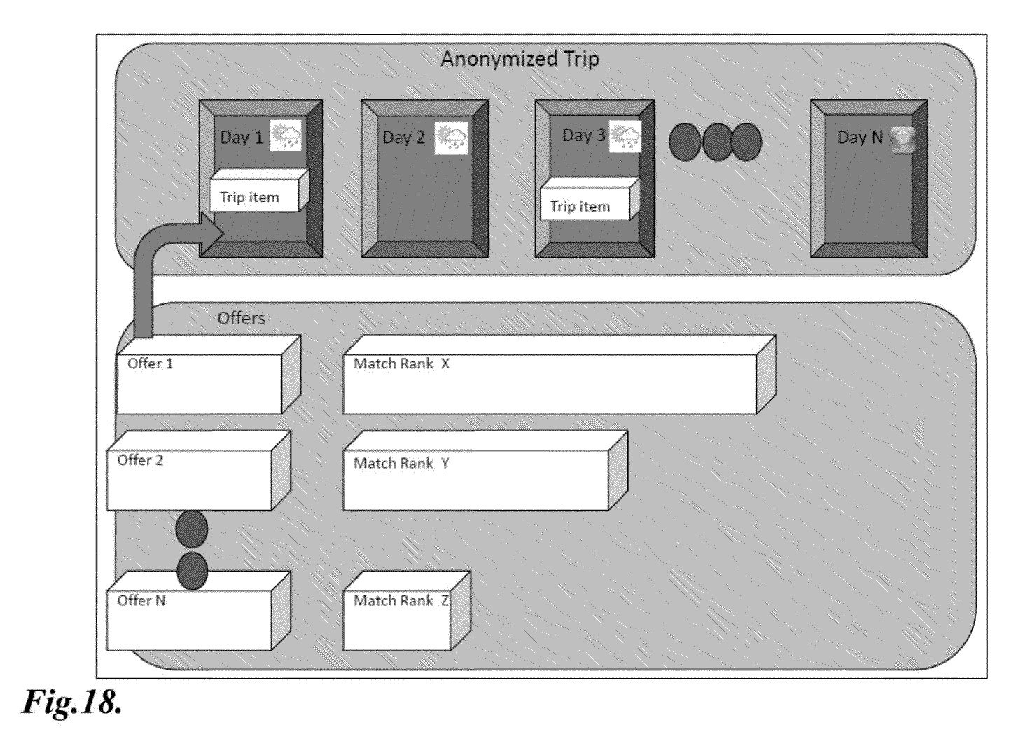

FIG. 18 illustrates an exemplary interface that presents a “supplier view” of a trip calendar, in accordance with various aspects of the present disclosure. As shown, the supplier view helps a supplier determine what custom offers to push to a trip. In various embodiments, a supplier may see an anonymous version of a trip calendar showing selected traveler information, booked trip items, history of check-ins, and the like. A supplier may also be presented with their offers and their respective match ranks for a particular trip.

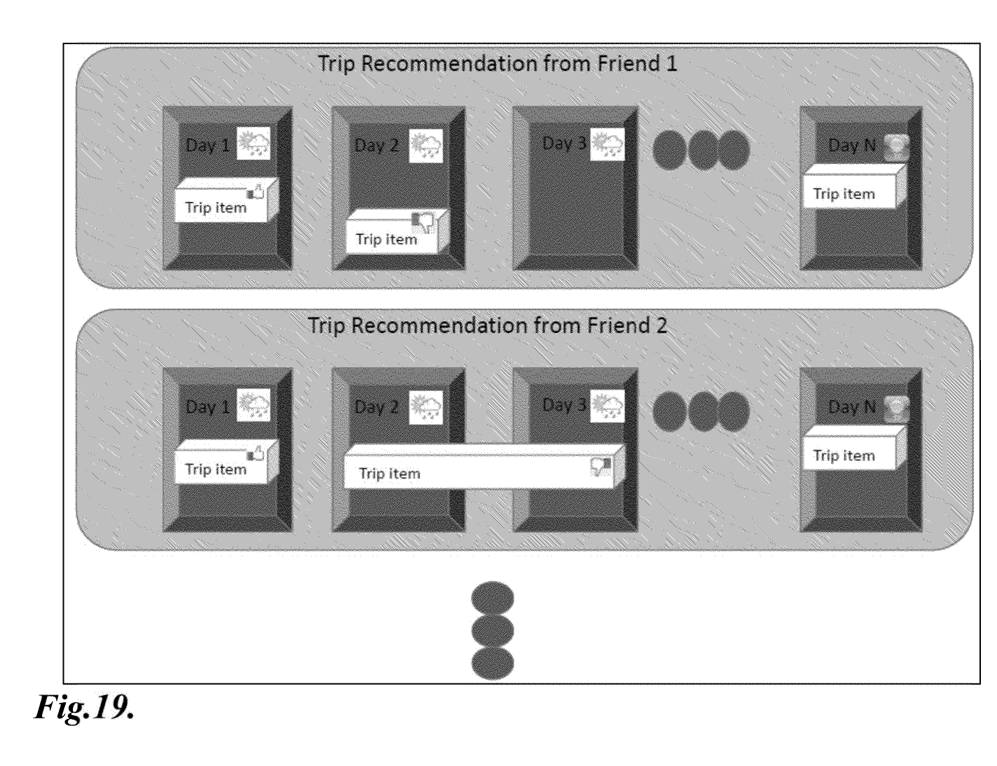

FIG. 19 illustrates an exemplary interface that presents trip recommendations received from social media service providers, according to various aspects of the present disclosure. The interface may allow the traveler to review the social recommendations, and/or to accept or reject recommended trip items.

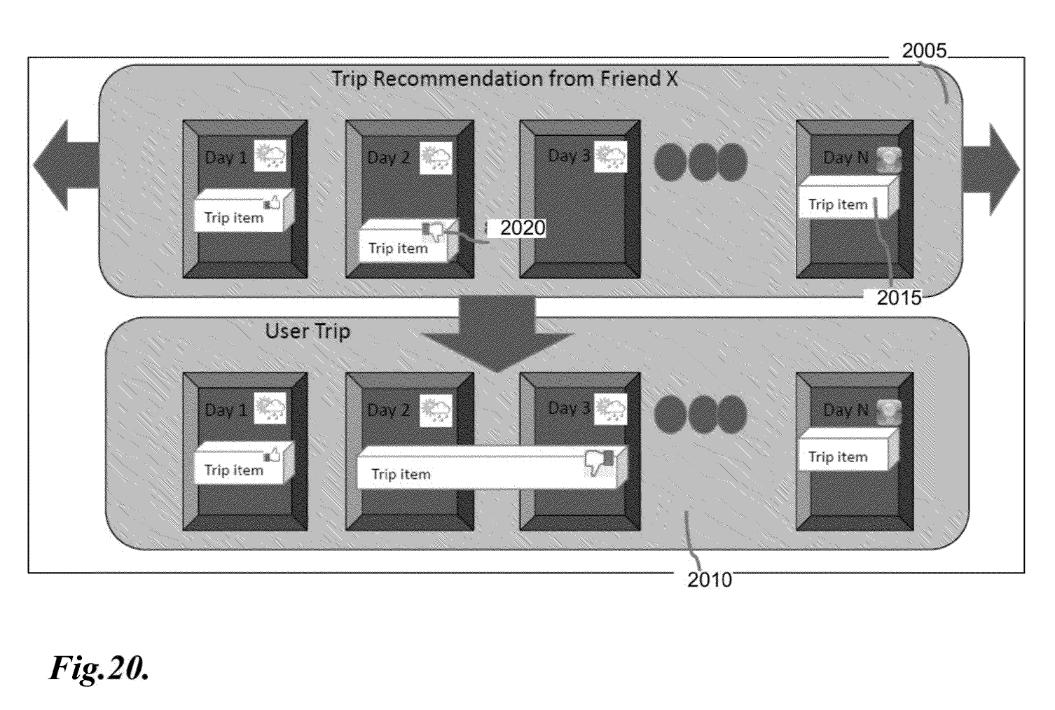

FIG. 20 illustrates an exemplary interface that enables the creation of a trip based on a list of variations of a dream trip posted by members of a social circle, in accordance with various aspects of the present disclosure. In this example, trip 2005 represents a version of a trip from someone other than the traveler. A traveler may create a new trip 2010 by copying a recommended trip 2005 or copy individual trip items (e.g., trip item 2015). A traveler may also use “likes” and “dislikes” of friends (e.g., like 2020) to aid in decisionmaking.

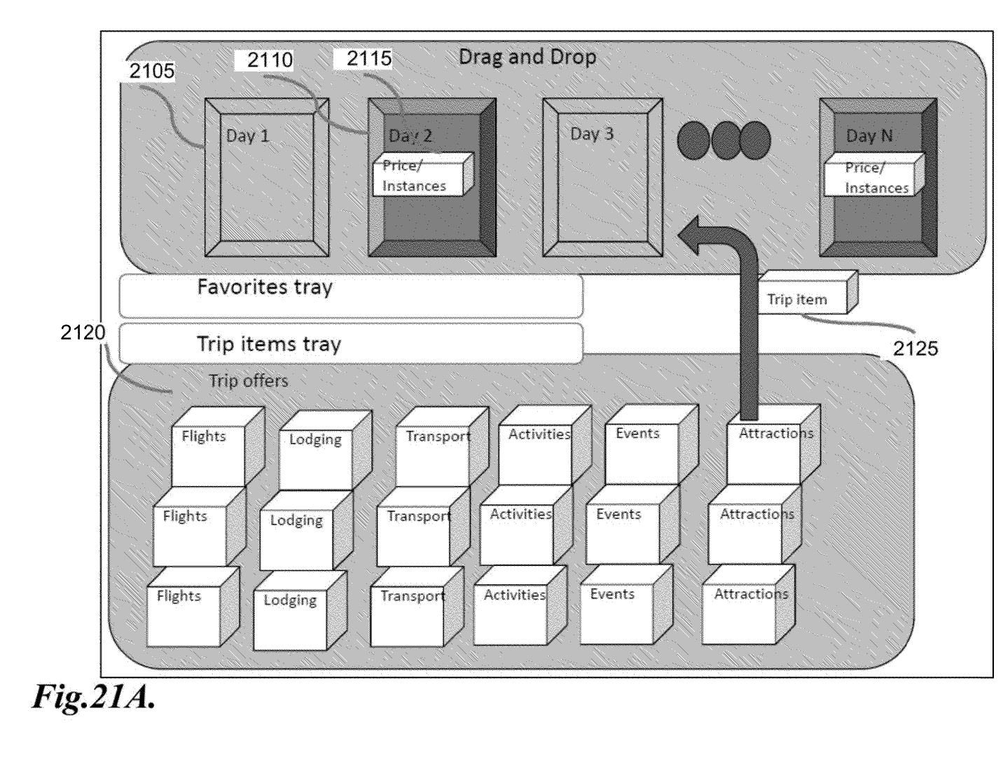

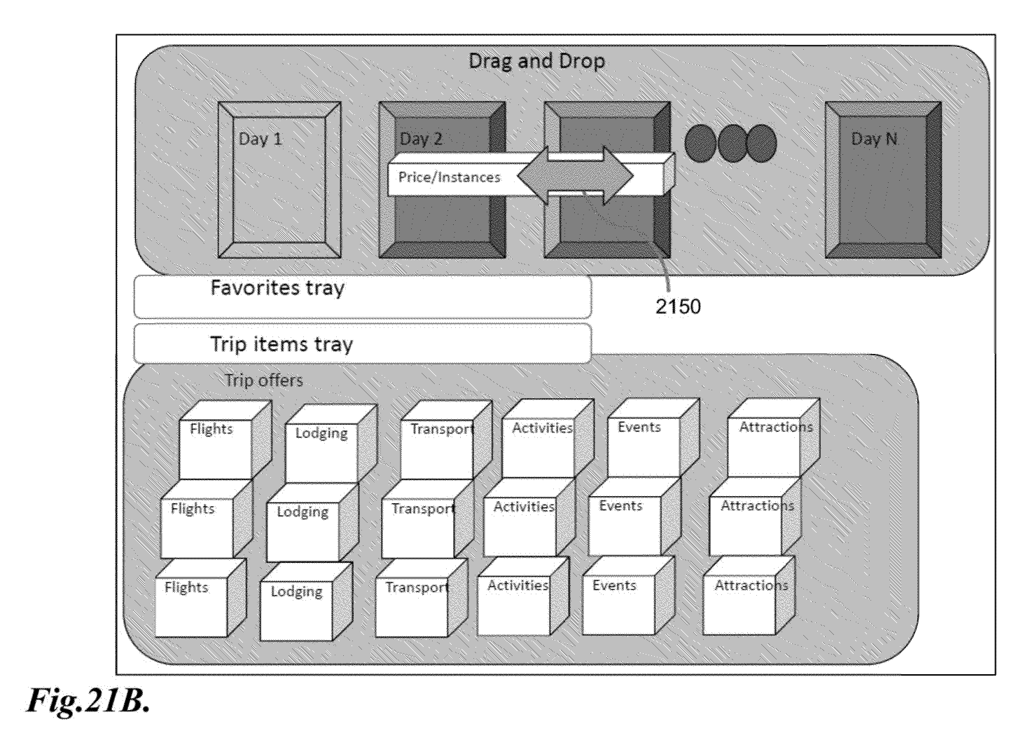

FIG. 21A illustrates an exemplary interface that presents a set of trip item offers to a traveler, and allows the traveler to add trip item offers to a calendar interface according to various aspects of the present disclosure. When pushed trip item offer 2125 is selected and dragged by a traveler from the collection of pushed trip item offers 2120, the selected pushed trip item offer (i.e., pushed trip item offer 2125) is reflected on the calendar interface along with its daily price(s) and availability. By comparing the terms and conditions of the pushed trip item offer with the selected day (i.e., the day that the traveler has dragged and dropped the trip item), a list of available instances of an offer may be displayed on a traveler's calendar interface. For example, pushed trip item offer 2125 is not available on trip day 2105 but is available on trip day 2110. Therefore, price and a list of available instances of the trip item offer on that day to choose from 2115 are shown on trip day 2110. Examples of multiple instances of an offer may include hourly tours, matinee show, night shows, and the like. In cases where a trip item may extend multiple days, such as for lodging, car rentals, or the like, a traveler may extend or reduce the duration of the trip item by stretching or shortening the trip item control 2150 in the calendar interface, as illustrated in FIG. 21B.

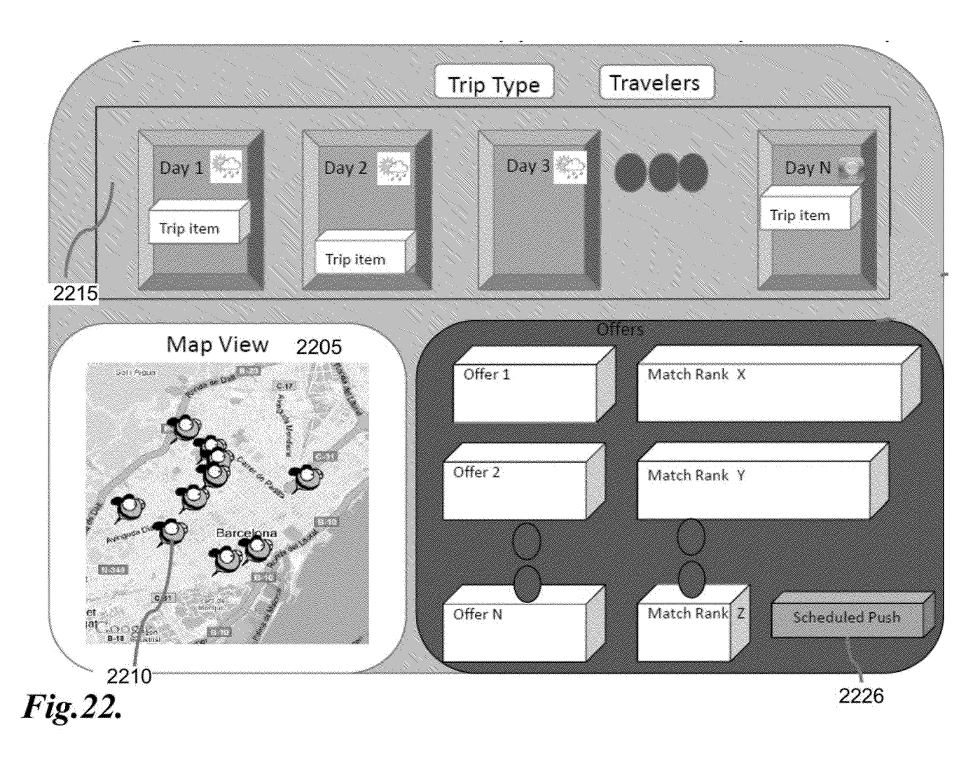

FIG. 22 illustrates an exemplary interface that presents a location-based supplier view of a specific trip, in accordance with various aspects of the present disclosure. Trip calendar 2215 is the representation of a trip. Map view 2205 shows the trip items on a map and a history of check-ins made by the traveler on that trip. Trip item offer list 2220 shows a list of the supplier's trip item offers and the corresponding match rank for the trip under consideration. Control 2226 allows the supplier to push a subset of the matching offers to the trip.

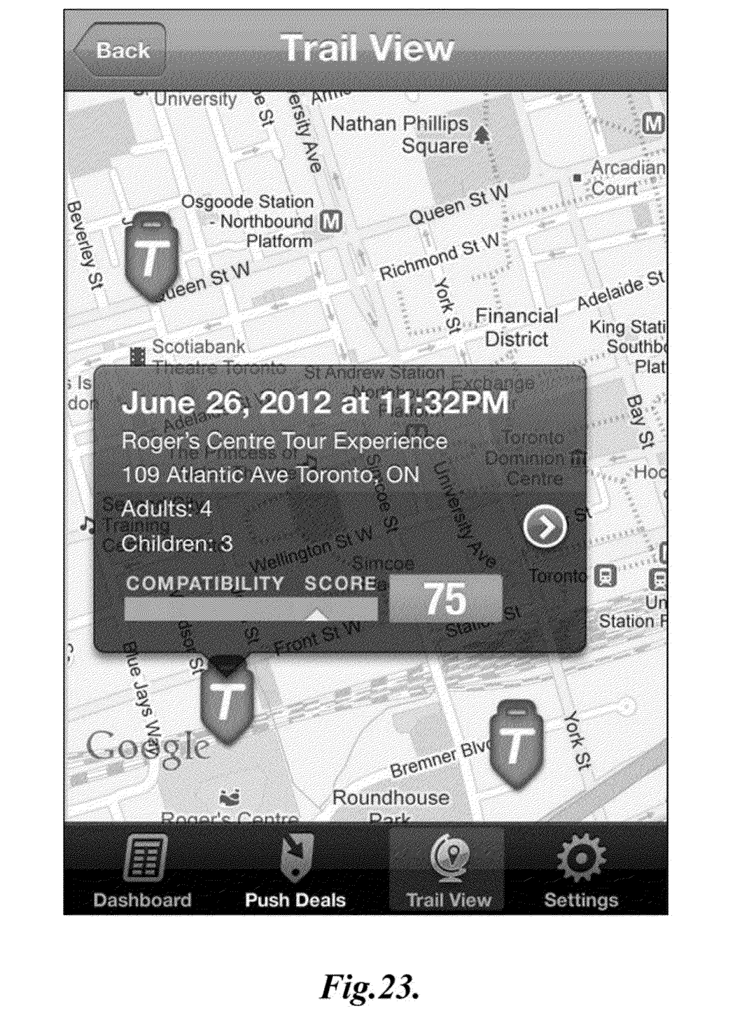

FIG. 23 illustrates an exemplary interface that presents a location-based supplier view, in accordance with various aspects of the present disclosure. The interface presents a map with various check-in locations that are part of one or more check-in trails or scheduled trip items in the future. By selecting a given check-in location or scheduled trip item, the supplier may be shown details about the given check-in (or the associated trip), including a match rank score indicating a compatibility between the trip and one or more trip items provided by the supplier.

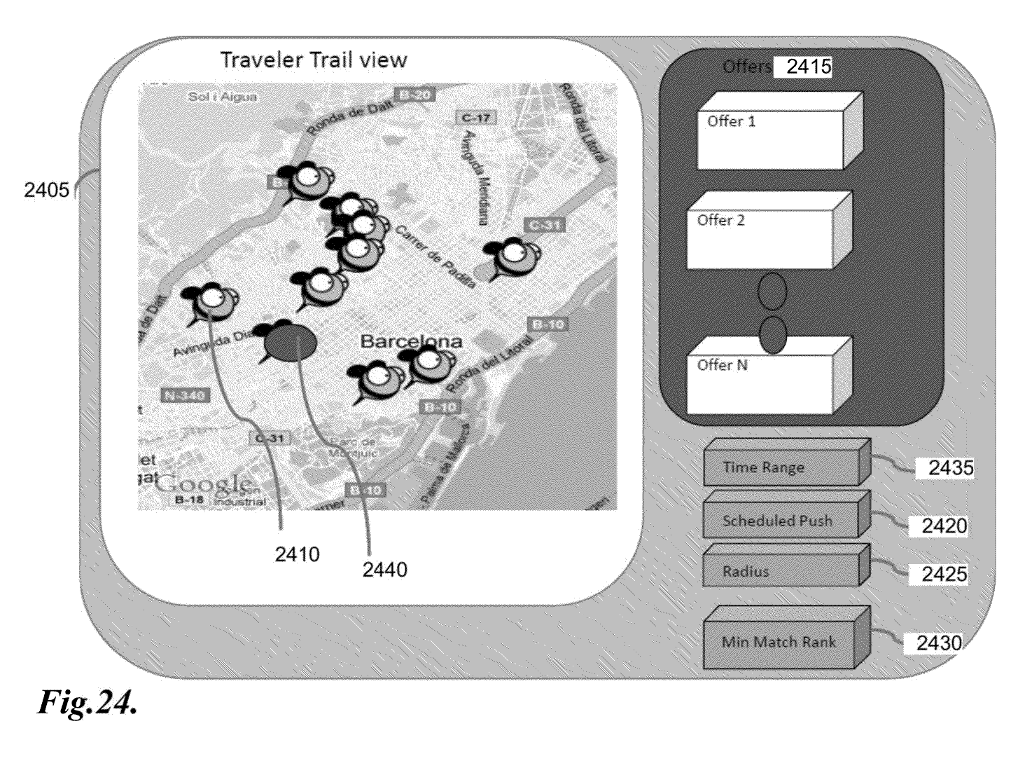

FIG. 24 illustrates an exemplary interface that presents a location-based supplier view of multiple trips, in accordance with various aspects of the present disclosure. Map view 2405 shows the check-ins made by travelers in a specified time range (control 2435) for a specified radius (control 2425) around a supplier location for a specified minimum match rank (control 2430). In some embodiments, a supplier location may be represented by an icon 2440 and a traveler may be represented by an icon 2410. In some embodiments, control 2420 allows a subset of offers to be pushed to every traveler that matches the criteria in the controls 2435, 2425 and 2430.

Exemplary Computing Device

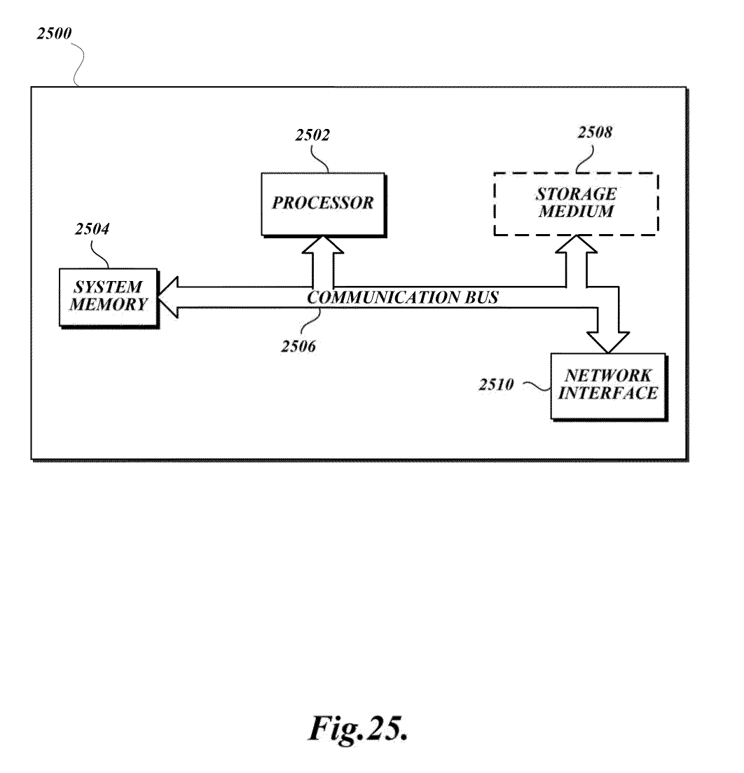

FIG. 25 illustrates aspects of an exemplary computing device 2500 appropriate for use with embodiments of the present disclosure. While FIG. 25 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 2500 may be any one of any number of currently available or yet to be developed devices.

In its most basic configuration, the computing device 2500 includes at least one processor 2502 and a system memory 2504 connected by a communication bus 2506. Depending on the exact configuration and type of device, the system memory 2504 may be volatile or nonvolatile memory, such as read only memory (“ROM”), random access memory (“RAM”), EEPROM, flash memory, or similar memory technology. Those of ordinary skill in the art and others will recognize that system memory 2504 typically stores data and/or program modules that are immediately accessible to and/or currently being operated on by the processor 2502. In this regard, the processor 2502 may serve as a computational center of the computing device 2500 by supporting the execution of instructions.

As further illustrated in FIG. 25, the computing device 2500 may include a network interface 2510 comprising one or more components for communicating with other devices over a network. Embodiments of the present disclosure may access basic services that utilize the network interface 2510 to perform communications using common network protocols. The network interface 2510 may also include a wireless network interface configured to communicate via one or more wireless communication protocols, such as WiFi, 2G, 3G, LTE, WiMAX, Bluetooth, and/or the like.

In the exemplary embodiment depicted in FIG. 25, the computing device 2500 also includes a storage medium 2508. However, services may be accessed using a computing device that does not include means for persisting data to a local storage medium. Therefore, the storage medium 2508 depicted in FIG. 25 is represented with a dashed line to indicate that the storage medium 2508 is optional. In any event, the storage medium 2508 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 2504 and storage medium 2508 depicted in FIG. 25 are merely examples of computer-readable media.

Suitable implementations of computing devices that include a processor 2502, system memory 2504, communication bus 2506, storage medium 2508, and network interface 2510 are known and commercially available. For ease of illustration and because it is not important for an understanding of the claimed subject matter, FIG. 25 does not show some of the typical components of many computing devices. In this regard, the computing device 2500 may include input devices, such as a keyboard, keypad, mouse, microphone, touch input device, touch screen, tablet, and/or the like. Such input devices may be coupled to the computing device 2500 by wired or wireless connections including RF, infrared, serial, parallel, Bluetooth, USB, or other suitable connections protocols using wireless or physical connections. Similarly, the computing device 2500 may also include output devices such as a display, speakers, printer, etc. Since these devices are well known in the art, they are not illustrated or described further herein.

As will be appreciated by one skilled in the art, the specific routines described above in the flowcharts may represent one or more of any number of processing strategies such as event-driven, interrupt-driven, multi-tasking, multi-threading, and the like. As such, various acts or functions illustrated may be performed in the sequence illustrated, in parallel, or in some cases omitted. Likewise, unless explicitly stated, the order of processing is not necessarily required to achieve the features and advantages, but is provided for ease of illustration and description. Although not explicitly illustrated, one or more of the illustrated acts or functions may be repeatedly performed depending on the particular strategy being used. Further, these FIGURES may graphically represent code to be programmed into a computer readable storage medium associated with a computing device.

Various principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the disclosed subject matter.

Though headings may be used above to denote sections of the detailed description, these headings are provided for ease of discussion only. The headings do not denote separate embodiments, and in some embodiments, discussion from separate headings may be combined into a single embodiment of the present disclosure.

The embodiments of the invention in which an exclusive property or privilege is claimed are defined as follows:

1. A system for travel planning, the system comprising at least one computing device configured to provide at least a traveler interface engine configured to:
present a trip calendar configured to present a set of scheduled trip items associated with a trip;
present a list of proposed trip items for selection;
receive a selection of a proposed trip item; and
add the selected proposed trip item to the trip calendar.

2. The system of claim 1, wherein the set of scheduled trip items includes trip items of more than one trip item type.

3. The system of claim 1, wherein the at least one computing device is further configured to provide a match rank engine configured to:
determine a set of match rank trip items based on one or more attributes of the trip; and
provide the set of match rank trip items to the traveler interface engine for presentation as proposed trip items.

4. The system of claim 3, wherein the one or more attributes of the trip include one or more preferences associated with the trip.

5. The system of claim 3, wherein the determination of the set of match rank trip items is also based on one or more attributes associated with the traveler.

6. The system of claim 3, wherein the one or more attributes of the trip include a start time, an end time, or a location of a scheduled trip item associated with the trip.

7. The system of claim 3, wherein determining a set of match rank trip items includes determining the set of match rank trip items based on a weather attribute or seasonality attribute of a potential match rank trip item.

8. The system of claim 1, wherein receiving a selection of a proposed trip item includes:
determining availability information for the selected proposed trip item; and
selectively enabling and disabling portions of the trip calendar for association with the selected proposed trip item based on the availability information.

9. The system of claim 1, wherein receiving a selection of a proposed trip item includes:
detecting a warning condition for the selected proposed trip item; and
presenting a warning relating to the warning condition;
wherein the warning condition includes one or more of:
a match rank score beneath a predetermined threshold;
an age restriction; and
travel time between a location associated with the selected proposed trip item and a location associated with a scheduled trip item.

10. The system of claim 1, wherein the at least one computing device is further configured to provide a booking engine configured to communicate with one or more supplier information systems to book one or more scheduled trip items.

11. The system of claim 1, wherein the at least one computing device is further configured to provide a social media interaction engine configured to:
transmit information associated with the trip to one or more social media service providers;
receive a set of social recommendation trip items from at least one of the one or more social media service providers; and
provide the set of social recommendation trip items to the traveler interface engine for presentation as proposed trip items.

12. The system of claim 1, wherein the traveler interface engine is further configured to present a trip planning interface, the trip planning interface including:
the trip calendar; and
one or more of:
a trip item tray;
a favorites tray;
a map interface that includes locations associated with one or more trip items; and
a journal interface.

13. The system of claim 12, wherein the trip planning interface allows the traveler to drag-and-drop a trip item from the trip item tray or the favorites tray to the trip calendar.

14. The system of claim 1, further comprising a trip data import engine configured to:
retrieve at least one third-party trip item from a third-party trip data source; and
add the at least one third-party trip items to the trip calendar.

15. The system of claim 1, wherein the traveler interface engine is further configured to:
receive information defining a manually input trip item from a traveler; and
add the manually input trip item to the trip calendar.

16. The system of claim 1, wherein the traveler interface engine is further configured to provide a journal interface, wherein the journal interface includes a presentation of media associated with a trip, and wherein the media associated with the trip is obtained from multiple sources.

17. The system of claim 16, wherein the journal interface is configured to provide navigation of the media associated with the trip based on interaction with the trip calendar.

18. A computer-implemented method for presenting trip items to a traveler, the method comprising:
receiving a set of trip item offers to be pushed to a traveler associated with a trip; and
for each trip item offer in the set of trip item offers:
determining an appropriate push event for causing the trip item offer to be pushed to the traveler; and
transmitting the trip item offer to the traveler for consideration in response to detecting the push event.

19. The computer-implemented method of claim 18, further comprising:
receiving one or more trip item offers from a supplier information system; and
storing the one or more trip item offers in a trip item data store.

20. The computer-implemented method of claim 19, wherein receiving a set of trip item offers includes:
presenting information associated with the trip and information associated with a proposed set of trip item offers from the offer data store to the supplier information system; and
receiving, from the supplier information system, a selection of trip item offers from the proposed set of trip item offers.

21. The computer-implemented method of claim 19, wherein receiving a set of trip item offers includes:
determining a match rank score for one or more trip item offers in the trip item data store; and
determining the received set of trip item offers based on the determined match rank scores.

22. The computer-implemented method of claim 21, wherein determining a match rank score for one or more trip item offers in the trip item data store includes comparing one or more attributes of one or more trip item offers to one or more preferences associated with the trip.

23. The computer-implemented method of claim 18, wherein determining an appropriate push event for causing the trip item offer to be pushed to the traveler includes:
determining predicted locations and times at which the traveler is predicted to be at the predicted locations based on scheduled trip items associated with the trip; and
comparing the predicted locations and times to a location associated with the trip item offer and an availability associated with the trip item offer.

24. The computer-implemented method of claim 18, wherein the appropriate push event includes one or more of:
a predetermined time;
a check-in at a predetermined location; and
a determination that a current location of the traveler is within a predetermined geographical area.

25. The computer-implemented method of claim 18, further comprising:
determining an expiration event for at least one trip item offer in the set of trip item offers; and
preventing presentation of the trip item offer to the traveler upon detection of the expiration event.

26. The computer-implemented method of claim 25, wherein the determination of the expiration event is based on at least an amount of an offered discount.

27. The computer-implemented method of claim 25, wherein the detection of the expiration event is based on at least one of:
an elapsed period of time since a first presentation of the trip item offer;
an elapsed period of time since a start of the trip;
a check-in outside of a predetermined geographic area;
a rejection by the traveler; and
a booking of a different trip item.
